(19) United States
(12) Patent Application Publication
(10) Pub. No.: US 2025/0181060 A1
(43) Pub. Date: Jun. 5, 2025

(54) EQUIPMENT RECOVERY NOTIFICATION METHOD, EQUIPMENT RECOVERY NOTIFICATION DEVICE, AND EQUIPMENT RECOVERY NOTIFICATION SYSTEM

(71) Applicant: Panasonic Intellectual Property Management Co., Ltd., Osaka (JP)

(72) Inventors: Hiroshi AMANO, Osaka (JP); Takuya MATSUMOTO, Hyogo (JP); Tomoya HIRATA, Osaka (JP); Takanori KAKIUCHI, Shiga (JP)

(21) Appl. No.: 18/841,960

(22) PCT Filed: Feb. 27, 2023
(86) PCT No.: PCT/JP2023/007170

§ 371 Date: Aug. 27, 2024

(30) Foreign Application Priority Data
Mar. 14, 2022 (JP) 2022-039705

(51) Int. Cl. G05B 19/418

(52) U.S. Cl. CPC G05B 19/41865

(57) ABSTRACT

An equipment recovery notification method includes: when two or more units of equipment among units of equipment that execute a first process are stopped, estimating, from among one or more units of subsequent-process equipment that execute a second process subsequent to the first process, a productivity of one or more units of the subsequent-process equipment that use at least one of components produced by the two or more units of equipment; identifying one unit of equipment among the two or more units of equipment as target equipment for recovery work, based on the productivity of the one or more units of subsequent-process equipment; and notifying of the identified target equipment.

### TECHNICAL FIELD

The present disclosure relates to an equipment recovery notification method, an equipment recovery notification device, and an equipment recovery notification system.

### BACKGROUND ART

Patent Literature (PTL) 1 discloses a production monitoring system that monitors the production status of each machine, determines the order of priority for machines that are stopped and must be recovered early, and displays the order of priority for all machines in sequence. In the production monitoring system of PTL 1, when a plurality of machines are stopped, the priority of each machine is determined by comparing the production quantity with a target value.

### CITATION LIST

### [Patent Literature]

[PTL 1] Japanese Unexamined Patent Application Publication No. 2010-26725

### SUMMARY OF INVENTION

### Technical Problem

However, with the conventional production monitoring system described above, there may be cases where productivity cannot be sufficiently improved.

Accordingly, the present disclosure provides an equipment recovery notification method and the like that can support the improvement of productivity.

### Solution to Problem

An equipment recovery notification method according to one aspect of the present disclosure includes: when two or more units of equipment among units of equipment that execute a first process are stopped, estimating, from among one or more units of subsequent-process equipment that execute a second process subsequent to the first process, a productivity of one or more units of the subsequent-process equipment that use at least one of components produced by the two or more units of equipment; identifying one unit of equipment among the two or more units of equipment as target equipment for recovery work, based on the productivity of the one or more units of subsequent-process equipment; and notifying of the target equipment identified.

An equipment recovery notification device according to one aspect of the present disclosure includes: an estimator that, when two or more units of equipment among units of equipment that execute a first process are stopped, estimates, from among one or more units of subsequent-process equipment that execute a second process subsequent to the first process, a productivity of one or more units of the subsequent-process equipment that use at least one of components produced by the two or more units of equipment; an identifier that identifies one unit of equipment among the two or more units of equipment as target equipment for recovery work, based on the productivity of the one or more units of subsequent-process equipment; and a notifier that notifies of the target equipment identified.

An equipment recovery notification system according to one aspect of the present disclosure includes: the equipment recovery notification device according to the one aspect described above; and a terminal device that outputs information for a worker of the recovery work to identify the target equipment.

Moreover, one aspect of the present disclosure can be realized as a program for causing a computer to execute the equipment recovery notification method described above. Alternatively, one aspect of the present disclosure can be realized as a non-transitory computer-readable recording medium having such a program recorded thereon.

### Advantageous Effects of Invention

With the equipment recovery notification method according to the present disclosure, it is possible to support the improvement of productivity.

### BRIEF DESCRIPTION OF DRAWINGS

FIG. 1 is a plan view illustrating a configuration of a factory in which an equipment recovery notification system according to Embodiment 1 is applied.

FIG. 2 illustrates the relationship between current-process equipment and subsequent-process equipment.

FIG. 3 is a block diagram illustrating the configuration of the equipment recovery notification system according to Embodiment 1.

FIG. 4 is a block diagram illustrating the configuration of manufacturing equipment according to Embodiment 1.

FIG. 5 is a block diagram illustrating the configuration of an equipment recovery notification device according to Embodiment 1.

FIG. 6 is a block diagram illustrating the configuration of a terminal device according to Embodiment 1.

FIG. 7 illustrates one example of equipment information.

FIG. 8 illustrates one example of work information.

FIG. 9 illustrates one example of component type information.

FIG. 10 illustrates one example of component-equipment correspondence information.

FIG. 11 illustrates another example of component-equipment correspondence information.

FIG. 12 illustrates one example of component characteristics information.

FIG. 13 illustrates one example of unused component information.

FIG. 14 illustrates one example of capacity information of subsequent-process equipment.

FIG. 15 illustrates one example of capacity information of subsequent-process equipment.

FIG. 16 is a sequence diagram illustrating a process for recording information and generating a model (learning phase) performed by the equipment recovery notification system according to Embodiment 1.

FIG. 17 is a sequence diagram illustrating a process for equipment recovery notification (usage phase) performed by the equipment recovery notification system according to Embodiment 1.

FIG. 18 is a flowchart illustrating a process for recording information that is performed by the equipment recovery notification system according to Embodiment 1.

FIG. 19 is a flowchart illustrating a process for generating models for a subsequent process performed by the equipment recovery notification system according to Embodiment 1.

FIG. 20 is a flowchart illustrating another example of a process for generating models for a subsequent process performed by the equipment recovery notification system according to Embodiment 1.

FIG. 21 is a flowchart illustrating an equipment recovery notification process performed by the equipment recovery notification system according to Embodiment 1.

FIG. 22 is a flowchart illustrating the process for estimating a required quantity of components performed by the equipment recovery notification system according to Embodiment 1.

FIG. 23 is a flowchart illustrating a process for displaying a notification image that is performed by the equipment recovery notification system according to Embodiment 1.

FIG. 24 is a flowchart illustrating a process, performed by an equipment recovery notification system according to Embodiment 2, for generating models for the current process.

FIG. 25 is a flowchart illustrating another example of a process for generating models for a current process performed by the equipment recovery notification system according to Embodiment 2.

FIG. 26 is a flowchart illustrating an equipment recovery notification process performed by the equipment recovery notification system according to Embodiment 2.

FIG. 27 is a flowchart illustrating the process for estimating an increment in production quantity performed by the equipment recovery notification system according to Embodiment 2.

FIG. 28 is a flowchart illustrating a priority setting process performed by the equipment recovery notification system according to Embodiment 2.

FIG. 29 illustrates an example of rules for setting priority by the equipment recovery notification system according to Embodiment 2.

FIG. 30 illustrates one example of a display screen displayed by the equipment recovery notification system according to the embodiments of the present disclosure.

FIG. 31 illustrates one example of transitions of display screens displayed by the equipment recovery notification system according to the embodiments of the present disclosure.

### DESCRIPTION OF EMBODIMENTS

### Overview of Present Disclosure

An equipment recovery notification method according to one aspect of the present disclosure includes: when two or more units of equipment among units of equipment that execute a first process are stopped, estimating, from among one or more units of subsequent-process equipment that execute a second process subsequent to the first process, a productivity of one or more units of the subsequent-process equipment that use at least one of components produced by the two or more units of equipment; identifying one unit of equipment among the two or more units of equipment as target equipment for recovery work, based on the productivity of the one or more units of subsequent-process equipment; and notifying of the target equipment identified.

This makes it possible to efficiently increase the productivity of the subsequent-process equipment by recovering the identified target equipment, since the productivity of the subsequent-process equipment is utilized. Therefore, the equipment recovery notification method according to the present embodiment can support the improvement of productivity.

For example, the identifying may include setting a priority for each of the two or more units of equipment based on the productivity of the one or more units of subsequent-process equipment, and identifying, from among the two or more units of equipment, a unit of equipment for which the priority set is higher than a threshold value as the target equipment.

This makes it possible to efficiently increase the productivity of the subsequent-process equipment when the identified target equipment is recovered based on the priority, since the priority is set based on the productivity of the subsequent-process equipment.

For example, the identifying may include setting a priority for each of the two or more units of equipment based on the productivity of the one or more units of subsequent-process equipment, comparing the priorities set, and identifying, from among the two or more units of equipment, a unit of equipment for which the priority set is higher than others as the target equipment.

This makes it possible to efficiently increase the productivity of the subsequent-process equipment when the identified target equipment is recovered based on the priority, since the priority is set based on the productivity of the subsequent-process equipment.

For example, when a first unit of equipment among the units of equipment is stopped and a second unit of equipment different from the first unit of equipment among the units of equipment stops, the estimating may include estimating a first component quantity and a second component quantity as the productivity of the one or more units of subsequent-process equipment, the first component quantity being a quantity, of a component produced by the first unit of equipment, required in a predetermined period in the second process, the second component quantity being a quantity, of a component produced by the second unit of equipment, required in the predetermined period in the second process, and the identifying may include comparing the first component quantity and the second component quantity, and (a) setting a priority of the first unit of equipment higher than a priority of the second unit of equipment when the first component quantity is greater than the second component quantity, and (b) setting the priority of the second unit of equipment higher than the priority of the first unit of equipment when the second component quantity is greater than the first component quantity.

The quantity of components required by the subsequent-process equipment is one of the indicators that directly represents the productivity of the subsequent-process equipment. By setting the priority based on this quantity of components, it is possible to appropriately identify the target equipment that contributes to the improvement of productivity.

For example, the estimating may include further estimating a productivity of each of the two or more units of equipment, and the identifying may include setting the priority for each of the two or more units of equipment further based on the productivity of each of the two or more units of equipment.

This makes it possible to identify target equipment suitable for improving the productivity of the entire production system including the current-process equipment and the subsequent-process equipment, since the productivity of the equipment of the first process (referred to as current-process equipment) is further utilized.

For example, when a first unit of equipment among the units of equipment is stopped and a second unit of equipment different from the first unit of equipment among the units of equipment stops, the estimating may include: estimating a first component quantity and a second component quantity as the productivity of the one or more units of subsequent-process equipment, the first component quantity being a quantity, of a first component produced by the first unit of equipment, required in a predetermined period in the second process, the second component quantity being a quantity, of a second component produced by the second unit of equipment, required in the predetermined period in the second process; and estimating a first increment quantity and a second increment quantity as a production quantity of each of the two or more units of equipment, the first increment quantity being a quantity by which the first component will increase in a case in which the first unit of equipment is recovered, and the second increment being a quantity by which the second component will increase in a case in which the second unit of equipment is recovered. The identifying may include (a) setting a priority of the first unit of equipment higher than a priority of the second unit of equipment when the first component quantity is greater than the second component quantity and the first increment quantity is greater than the second increment quantity, and (b) setting the priority of the second unit of equipment higher than the priority of the first unit of equipment when the second component quantity is greater than the first component quantity and the second increment quantity is greater than the first increment quantity.

The quantity of components required by the subsequent-process equipment is one of the indicators that directly represents the productivity of the subsequent-process equipment. The increment quantity produced by the current-process equipment is one of the indicators that directly represents the productivity of the current-process equipment. By setting the priority based on this component quantity and increment quantity, it is possible to appropriately identify the target equipment that contributes to the improvement of productivity.

For example, the equipment recovery notification method according to one aspect of the present disclosure may further include obtaining weight information indicating a weight of the first process and a weight of the second process. The identifying may include: multiplying each of the first component quantity and the second component quantity by the weight of the second process; multiplying each of the first increment quantity and the second increment quantity by the weight of the first process; calculating a first evaluation value and a second evaluation value, the first evaluation value being a sum of the first component quantity multiplied by the weight of the second process and the first increment quantity multiplied by the weight of the first process, the second evaluation value being a sum of the second component quantity multiplied by the weight of the second process and the second increment quantity multiplied by the weight of the first process; and (a) setting the priority of the first unit of equipment higher than the priority of the second unit of equipment when the first evaluation value is greater than the second evaluation value, and (b) setting the priority of the second unit of equipment higher than the priority of the first unit of equipment when the second evaluation value is greater than the first evaluation value.

This makes it possible to place emphasis on the process that is more likely to contribute to the improvement of productivity by utilizing the weights of the current process and the subsequent process. This makes it possible to support the improvement of productivity of the entire production system.

For example, the equipment recovery notification method according to one aspect of the present disclosure may further include obtaining weight information indicating a weight of the first process and a weight of the second process. (i) When the weight of the second process is greater than the weight of the first process, the identifying may include: (a) setting the priority of the first unit of equipment higher than the priority of the second unit of equipment when the first component quantity is greater than the second component quantity and the first increment quantity is less than the second increment quantity; and (b) setting the priority of the second unit of equipment higher than the priority of the first unit of equipment when the second component quantity is greater than the first component quantity and the second increment quantity is less than the first increment quantity, and (ii) when the weight of the first process is greater than the weight of the second process, the identifying may include: (a) setting the priority of the second unit of equipment higher than the priority of the first unit of equipment when the first component quantity is greater than the second component quantity and the first increment quantity is less than the second increment quantity; and (b) setting the priority of the first unit of equipment higher than the priority of the second unit of equipment when the second component quantity is greater than the first component quantity and the second increment quantity is less than the first increment quantity.

This makes it possible to place emphasis on the process that is more likely to contribute to the improvement of productivity by utilizing the weights of the current process and the subsequent process. This makes it possible to support the improvement of productivity of the entire production system.

For example, the estimating may include: estimating a first usage quantity and a second usage quantity, the first usage quantity being a quantity of the first component to be used in the predetermined period in the second process, the second usage quantity being a quantity of the second component to be used in the predetermined period in the second process; obtaining a first unused quantity and a second unused quantity, the first unused quantity being a quantity of the first component that has not yet been used in the second process, the second unused quantity being a quantity of the second component that has not yet been used in the second process; calculating the first component quantity by subtracting the first unused quantity from the first usage quantity; and calculating the second component quantity by subtracting the second unused quantity from the second usage quantity.

This makes it possible to calculate the quantity of components required by the subsequent-process equipment as a value that is more in line with actual circumstances by utilizing the quantity of unused produced components. Therefore, since the priority set based on the component quantity is set more appropriately, it is possible to appropriately identify the target equipment that contributes to the improvement of productivity.

For example, the estimating may include: when the subsequent-process equipment includes a plurality of units of subsequent-process equipment that use the first component, estimating, for each of the plurality of units of subsequent-process equipment, a quantity of the first component to be used in the predetermined period, and calculating the first usage quantity by summing the quantities estimated; and when the subsequent-process equipment includes a plurality of units of subsequent-process equipment that use the second component, estimating, for each of the plurality of units of subsequent-process equipment, a quantity of the second component to be used in the predetermined period, and calculating the second usage quantity by summing the quantities estimated.

This makes it possible to calculate the quantity of components required as a value that is more in line with actual circumstances when the components produced by a unit of current-process equipment are used by a plurality of subsequent-process equipment. Therefore, since the priority set based on the component quantity is set more appropriately, it is possible to appropriately identify the target equipment that contributes to the improvement of productivity.

For example, the estimating may include: when a unit of the subsequent-process equipment that uses the first component satisfies a predetermined condition, setting a quantity of the first component to be used by the unit of the subsequent-process equipment to zero; and when a unit of the subsequent-process equipment that uses the second component satisfies a predetermined condition, setting a quantity of the second component to be used by the unit of the subsequent-process equipment to zero.

This makes it possible to set the quantity of components used by the subsequent-process equipment to zero when predetermined conditions are satisfied, such as the subsequent-process equipment being stopped according to a planned stop or being under maintenance. By omitting the processing required for estimating the component quantity, it is possible to reduce the amount of computation.

For example, the equipment recovery notification method according to one aspect of the present disclosure may further include: obtaining: equipment information including an operating and stoppage status of each of the units of equipment, an operating and stoppage status of each of the one or more units of subsequent-process equipment, and a stoppage factor of each of the one or more units of subsequent-process equipment that is stopped; component type information including a type of component produced by each of the units of equipment; and correspondence information indicating, for each type of component produced by the units of equipment, the subsequent-process equipment that uses the component in the second process. In the estimating, the productivity of the one or more units of subsequent-process equipment may be estimated by inputting the first equipment information, the second equipment information, the factor information, the component type information, and the correspondence information into a machine learning model generated by machine learning.

This makes it possible to improve productivity estimation accuracy by utilizing machine learning. The longer the operating time of the production system and the more data used for machine learning, the more the estimation accuracy improves, making it possible to identify the optimal target equipment that contributes to the improvement of productivity.

For example, the notifying may include displaying a notification image in which two or more items of equipment identification information respectively representing the two or more units of equipment are arranged in descending order of priority of the two or more units of equipment.

This makes it possible for the worker to easily comprehend which unit of equipment is the target equipment, since the equipment identification information is arranged in order of priority from highest to lowest. This makes it possible to promptly start on recovery work, thereby enabling support for further improvement of productivity.

For example, the notifying may include updating the notification image each time there is an increase or decrease in the two or more units of equipment.

This makes it possible for the notification image to be updated each time there is an increase or decrease in stopped equipment, such as when a new equipment stoppage occurs or when equipment starts operation as a result of recovery work being completed. Therefore, since this makes it possible to transmit a notification of the appropriate target equipment according to changes in the situation, the system excels in real-time performance, and can support the further improvement of productivity.

For example, when a first unit of equipment among the units of equipment is stopped and a second unit of equipment different from the first unit of equipment among the units of equipment stops, the estimating may include estimating a first component quantity and a second component quantity as the productivity of the one or more units of subsequent-process equipment, the first component quantity being a quantity, of a component produced by the first unit of equipment, required in a predetermined period in the second process, the second component quantity being a quantity, of a component produced by the second unit of equipment, required in the predetermined period in the second process, and the identifying may include comparing the first component quantity and the second component quantity, and (i) identifying the first unit of equipment as the target equipment when the first component quantity is greater than the second component quantity, and (ii) identifying the second unit of equipment as the target equipment when the second component quantity is greater than the first component quantity.

With this, the quantity of components required by the subsequent-process equipment is one of the indicators that directly represents the productivity of the subsequent-process equipment. It is possible to appropriately identify the target equipment that contributes to improving productivity, based on the relative quantities of the component.

An equipment recovery notification device according to one aspect of the present disclosure includes: an estimator that, when two or more units of equipment among units of equipment that execute a first process are stopped, estimates, from among one or more units of subsequent-process equipment that execute a second process subsequent to the first process, a productivity of one or more units of the subsequent-process equipment that use at least one of components produced by the two or more units of equipment; an identifier that identifies one unit of equipment among the two or more units of equipment as target equipment for recovery work, based on the productivity of the one or more units of subsequent-process equipment; and a notifier that notifies of the target equipment identified.

This makes it possible to efficiently increase the productivity of the subsequent-process equipment by recovering the identified target equipment, since the productivity of the subsequent-process equipment is utilized. Therefore, the equipment recovery notification device according to the present embodiment can support the improvement of productivity.

An equipment recovery notification system according to one aspect of the present disclosure includes: the equipment recovery notification device according to the one aspect described above; and a terminal device that outputs information for a worker of the recovery work to identify the target equipment.

This makes it possible to efficiently increase the productivity of the subsequent-process equipment by recovering the identified target equipment, since the productivity of the subsequent-process equipment is utilized. Therefore, the equipment recovery notification system according to the present embodiment can support the improvement of productivity.

Hereinafter, one or more embodiments will be described in detail with reference to the drawings.

Each embodiment described below shows a general or specific example. The numerical values, shapes, materials, elements, the arrangement and connection of the elements, steps, order of the steps etc., indicated in the following embodiments are mere examples, and therefore do not intend to limit the present disclosure. Therefore, among elements in the following embodiments, those not recited in any of the independent claims are described as optional elements.

The figures are schematic illustrations and are not necessarily precise depictions. Accordingly, the figures are not necessarily to scale. Moreover, in the figures, the same reference signs are used for elements that are essentially the same. Accordingly, duplicate description is omitted or simplified.

### Embodiment 1

1-1. Example of Factory in which Equipment Recovery Notification System is Applied

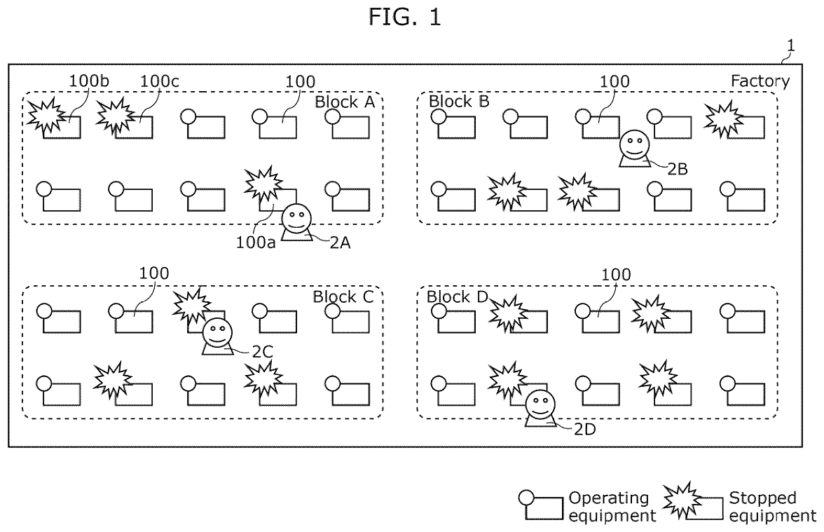

First, an example of a factory in which an equipment recovery notification system according to an embodiment of the present disclosure is applied will be described with reference to FIG. 1. FIG. 1 is a plan view illustrating a configuration of factory 1 in which an equipment recovery notification system according to the present embodiment is applied.

As illustrated in FIG. 1, a plurality of units of manufacturing equipment 100 are arranged in factory 1. Each of the plurality of units of manufacturing equipment 100 executes one process among a plurality of processes for manufacturing a product. Manufacturing equipment 100 is, for example, a component mounting machine, a processing device, or an assembly device, but manufacturing equipment 100 is not particularly limited. Manufacturing equipment 100 produces components by executing processes, and outputs the produced components.

Components are, for example, parts included in the final product (that is, the product), or an unfinished part in the middle of the manufacturing of the final product, but components are not limited to these examples. Components are items used to produce parts or unfinished parts, and do not need to be included in the final product. Manufacturing equipment 100 may be any equipment involved in the manufacturing of products, and may be an inspection device that inspects components, unfinished parts, or products.

In the present specification, the terms “produce” or “production” or any other variation thereof means not only creating the final product, but also includes processing, assembly, and inspection of components (parts or unfinished parts). For example, a component produced by manufacturing equipment 100 is a component output after manufacturing equipment 100 executes a process (processing, assembly, inspection, etc.) assigned to manufacturing equipment 100. Moreover, “manufacturing” is an example of production, and in the case where the final product is an industrial product, “manufacturing” is used with the same meaning as “production”.

A plurality of workers 2A to 2D are engaged in work in factory 1. In the example illustrated in FIG. 1, factory 1 is divided into 4 blocks A to D, and a worker is assigned to each block. For example, worker 2A performs recovery work for ten units of manufacturing equipment 100 arranged in block A. Hereinafter, explanation will be given regarding worker 2A, but the same applies to workers 2B to 2D.

In the event that manufacturing equipment 100 stops, worker 2A performs recovery work for the stopped manufacturing equipment 100. Here, as illustrated in FIG. 1, it is possible that a plurality of units of manufacturing equipment 100a to 100c will simultaneously stop. For example, in the event that manufacturing equipment 100a stops, worker 2A performs recovery work on manufacturing equipment 100a, but it is possible that manufacturing equipment 100b and 100c will stop before the recovery work on manufacturing equipment 100a is completed. In the event that a plurality of units of manufacturing equipment 100 stop, by recovering the stopped manufacturing equipment 100 in an appropriate order, the productivity of factory 1 as a whole can be increased.

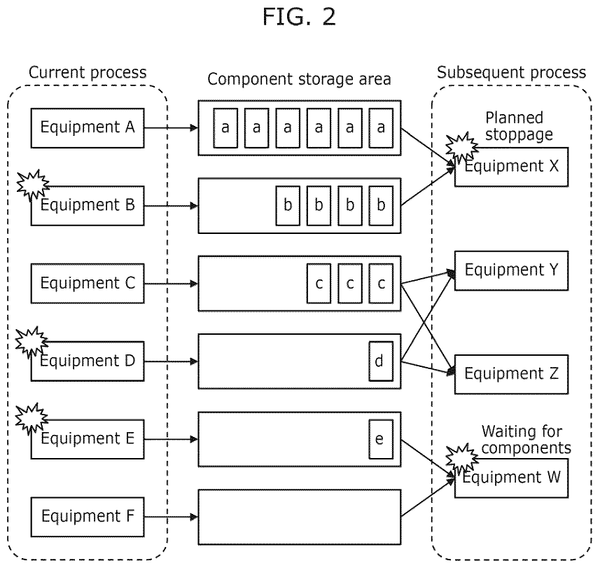

Hereinafter, the relationships between units of manufacturing equipment 100 and points that may become problematic when specifying equipment subject to recovery work (hereinafter also “target equipment”) will be described with reference to FIG. 2.

FIG. 2 illustrates the relationship between current-process equipment and subsequent-process equipment.

The current-process equipment is equipment that executes the current process. The current process is one example of the first process, and is a process performed by equipment subject to notification by the equipment recovery notification system according to the present embodiment. Stated differently, when two or more of the plurality of units of equipment executing the first process are stopped, the equipment recovery notification system according to the present embodiment identifies one of the two or more units of equipment as the target equipment and notifies of such. For example, the ten units of manufacturing equipment 100 belonging to block A illustrated in FIG. 1 correspond to the current-process equipment. FIG. 2 illustrates six units of equipment, namely equipment A to F.

As illustrated in FIG. 2, the components produced by each of the plurality of units of current-process equipment are temporarily stored in the component storage area before being used by the subsequent-process equipment. The component storage area may be a part of a conveying device that conveys components from the current-process equipment to the subsequent-process equipment. In the present embodiment, a component storage area is provided for each unit of current-process equipment. For example, component “a” produced by equipment A is stored in the component storage area of equipment A.

The subsequent-process equipment is equipment that executes the subsequent process. The subsequent process is one example of the second process, and is the process immediately following the first process. The subsequent-process equipment executes the second process using one or more components produced by the current-process equipment. For example, the ten units of manufacturing equipment 100 belonging to block B illustrated in FIG. 1 correspond to the subsequent-process equipment. FIG. 2 illustrates four units of equipment, namely equipment W to Z.

In the example illustrated in FIG. 2, equipment X uses component “a” produced by equipment and component “b” produced by equipment B. Equipment Y uses component “c” produced by equipment C and component “d” produced by equipment D. Equipment Z uses component “c” produced by equipment C and component “d” produced by equipment D. Equipment W uses component “e” produced by equipment E and component “f” produced by equipment F.

FIG. 2 illustrates the situation in a factory in operation at a certain point in time. More specifically, equipment A, C, and F corresponding to the current process are operating, while equipment B, D, and E corresponding to the current process are stopped. Six components “a”, four components “b”, three components “c”, one component “d”, and one component “e” are respectively stored in the component storage areas corresponding equipment A to E. Component storage area of equipment F is not storing any component “f” produced by equipment F. Equipment X corresponding to the subsequent process is in a long-term planned stoppage. Equipment Y and Z corresponding to the subsequent process are operating. Equipment W corresponding to the subsequent process is stopped waiting for supply of component “f” because there is no component “f” to use.

In this situation, when a single worker performs recovery work on equipment B, D, and E, which are stopped in the current process, it is important to determine which equipment among equipment B, D, and E should be recovered. For example, when determining the target equipment for recovery work taking into consideration the productivity of the current-process equipment, if the productivity of equipment B is the highest, equipment B is determined to be subject to recovery work. However, even if equipment B is recovered, component “b” produced by equipment B will not be used by equipment X because equipment X corresponding to the subsequent process is in a planned stoppage. Therefore, even if equipment B is recovered, productivity will not improve unless equipment X is operating. In this way, even if the productivity of the current-process equipment is taken into consideration, doing so does not necessarily lead to improved productivity.

In contrast, in the equipment recovery notification system according to the present embodiment, the productivity of the subsequent-process equipment is estimated, and the target equipment is identified and a notification indicating such is made based on the estimated productivity. This makes it possible to support the improvement of productivity.

For example, as described above, because equipment X in the subsequent process is in a planned stoppage, recovering equipment B that produces component “b” used by equipment X will not lead to improved productivity. The priority of equipment B therefore decreases. Equipment W is also stopped waiting for components, and the component that is lacking is component “f”. Equipment F that produces component “f” is operating. Since the component “e” used by equipment W is currently stored in the component storage area, even if equipment E is recovered, it does not necessarily lead to improved productivity.

In contrast, equipment Y and Z are each operating, and components “c” and “d”, which both equipment Y and Z use, are currently stored in the component storage area. However, since only one component “d” is in the component storage area, it will soon be used up. If the supply of component “d” stops, both equipment Y and Z will stop due to waiting for components, and productivity will decrease. Therefore, by recovering equipment D and having it produce component “d”, the stoppage of equipment Y and Z due to waiting for components can be avoided, and productivity can be improved. Accordingly, equipment D can be determined as the target equipment for recovery work.

In this way, with the equipment recovery notification system according to the present embodiment, the productivity of the subsequent-process equipment is estimated, and the target equipment is identified and a notification indicating such is made based on the estimated productivity, thereby supporting the improvement of productivity.

### 1-2. Equipment Recovery Notification System

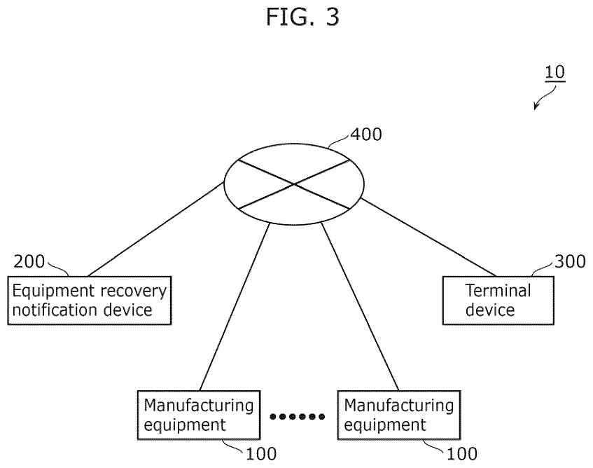

Hereinafter, a specific configuration of the equipment recovery notification system according to the present embodiment will be described with reference to FIG. 3 through FIG. 6.

FIG. 3 is a block diagram illustrating the configuration of equipment recovery notification system 10 according to the present embodiment. As illustrated in FIG. 3, equipment recovery notification system 10 includes a plurality of units of manufacturing equipment 100, equipment recovery notification device 200, and terminal device 300. The plurality of units of manufacturing equipment 100, equipment recovery notification device 200, and terminal device 300 are communicably connected to each other via network 400. The communication between each device may be wired or wireless communication. Terminal device 300 may also serve as equipment recovery notification device 200. Terminal device 300 may also be provided for each worker.

### 1-2-1. Manufacturing Equipment

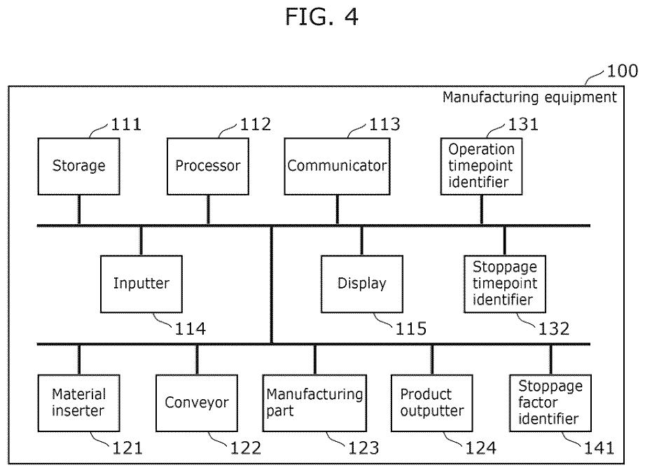

First, the configuration of manufacturing equipment 100 will be described with reference to FIG. 4. FIG. 4 is a block diagram illustrating the configuration of manufacturing equipment 100 according to the present embodiment.

As illustrated in FIG. 4, manufacturing equipment 100 includes storage 111, processor 112, communicator 113, inputter 114, display 115, material inserter 121, conveyor 122, manufacturing part 123, product outputter 124, operation timepoint identifier 131, stoppage timepoint identifier 132, and stoppage factor identifier 141. The elements of manufacturing equipment 100 are communicably connected to each other.

Storage 111 is memory for storing equipment information, data, and programs related to manufacturing equipment 100. For example, storage 111 stores the equipment name (for example, identification number) of manufacturing equipment 100 and the type of parts to be produced. Storage 111 may store a production plan and operating performance information (operation timepoint, stoppage timepoint, stoppage factor, etc.). Storage 111 is implemented as a non-volatile storage device such as a hard disk drive (HDD) or semiconductor memory.

Processor 112 performs processing for controlling the overall operation of manufacturing equipment 100. Processor 112 is implemented, for example, as a processor. Processor 112 generates instructions for controlling each element of manufacturing equipment 100, and outputs the instructions to each element. Processor 112 also generates and stores in storage 111 operation results (manufacturing log information) such as details of processing performed by each element and the timepoint of occurrence of events.

Communicator 113 is a communication interface for manufacturing equipment 100 to communicate with other devices. Communicator 113, for example, communicates with equipment recovery notification device 200 to transmit the equipment name, type of component to be produced, stoppage timepoint, stoppage factor, and operation timepoint to equipment recovery notification device 200.

Inputter 114 accepts operation inputs to manufacturing equipment 100 from a worker. Inputter 114 is realized, for example, by physical operation buttons, but may be a touch panel display and/or a voice input device. For example, processor 112 may regard the timepoint at which inputter 114 accepted input from the worker as the arrival timepoint of the worker. The arrival timepoint of the worker can be regarded as the point in time at which the worker started the recovery work (work start timepoint).

Display 115 is for displaying an operation state and the like of manufacturing equipment 100. Display 115 is implemented as a liquid crystal display or organic electroluminescent (EL) display device, for example.

Material inserter 121 is a device that inserts materials used for manufacturing products. The materials are, for example, resin or metal materials before molding, resin or metal parts after molding, or substrates or circuit components or the like, but are not particularly limited. The materials are gases, liquids, solids, powders, or pellets or the like. When manufacturing equipment 100 is subsequent-process equipment, material inserter 121 inserts, as materials, components produced by current-process equipment.

Conveyor 122 conveys the materials inserted by material inserter 121 to manufacturing part 123. Conveyor 122 conveys the products (components) manufactured by manufacturing part 123 to product outputter 124. Conveyor 122 is realized, for example, by a conveyor belt, an actuator, and/or a motor, but is not particularly limited.

Manufacturing part 123 performs production (manufacturing) of components using the inserted materials. Manufacturing part 123 is a device that performs at least one process related to manufacturing such as assembly, bonding, or welding of components.

Product outputter 124 is a device that outputs the components (unfinished parts) produced by manufacturing part 123.

Material inserter 121, conveyor 122, manufacturing part 123, and product outputter 124 each include one or more sensors for detecting the state of processing of each part. The sensor output results are output to processor 112, operation timepoint identifier 131, stoppage timepoint identifier 132, and/or stoppage factor identifier 141.

Operation timepoint identifier 131 identifies the operation timepoint of manufacturing equipment 100. More specifically, operation timepoint identifier 131 identifies, as the operation timepoint, the point in time at which production of components started based on the output results of each sensor. Operation timepoint identifier 131 identifies the operation timepoint each time production of components starts as well as each time production restarts (recovers) after stopping.

Stoppage timepoint identifier 132 identifies the stoppage timepoint of manufacturing equipment 100. More specifically, stoppage timepoint identifier 132 identifies, as the stoppage timepoint, the point in time at which production of components stopped based on the output results of each sensor. Stoppage timepoint identifier 132 identifies stoppage timepoint each time manufacturing equipment 100 stops.

Stoppage factor identifier 141 identifies the stoppage factor of manufacturing equipment 100. More specifically, stoppage factor identifier 141 identifies, as the stoppage factor, the factor that caused manufacturing equipment 100 to stop based on the output results of each sensor. Stoppage factor identifier 141 identifies stoppage factor each time manufacturing equipment 100 stops.

For example, operation timepoint identifier 131, stoppage timepoint identifier 132, and stoppage factor identifier 141 are each realized as, but not limited to, a dedicated integrated circuit. The processing performed by each of operation timepoint identifier 131, stoppage timepoint identifier 132, and stoppage factor identifier 141 may be performed by processor 112 executing a predetermined program.

The configuration of manufacturing equipment 100 is not limited to the example illustrated in FIG. 4. For example, it is acceptable if manufacturing equipment 100 does not include at least one of operation timepoint identifier 131, stoppage timepoint identifier 132, or stoppage factor identifier 141.

### 1-2-2. Equipment Recovery Notification Device

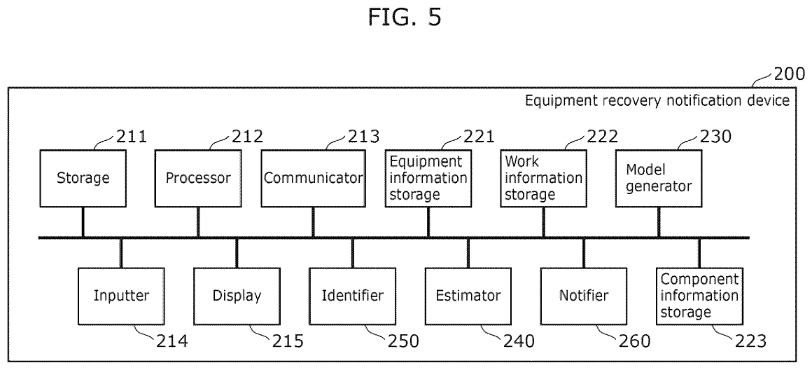

Next, the configuration of equipment recovery notification device 200 will be described with reference to FIG. 5. FIG. 5 is a block diagram illustrating the configuration of equipment recovery notification device 200 according to the present embodiment.

Equipment recovery notification device 200 is a computing device that performs the main processing of equipment recovery notification system 10. Equipment recovery notification device 200 is, for example, a computer device that includes a processor and memory. The processor reads and executes a program stored in the memory to execute predetermined processing. Note that at least a part of the processing executed by equipment recovery notification device 200 may be executed by a dedicated circuit.

As illustrated in FIG. 5, equipment recovery notification device 200 includes storage 211, processor 212, communicator 213, inputter 214, display 215, equipment information storage 221, work information storage 222, component information storage 223, model generator 230, estimator 240, identifier 250, and notifier 260. The elements of equipment recovery notification device 200 are communicably connected to each other.

Storage 211 is memory for storing information, data, and programs for operating equipment recovery notification device 200. Storage 211 is implemented as a non-volatile storage device such as an HDD or semiconductor memory. Storage 211 may be implemented using hardware resources shared by at least one of equipment information storage 221, work information storage 222, or component information storage 223.

Processor 212 performs processing for controlling the overall operation of equipment recovery notification device 200. Processor 212 is implemented, for example, as a processor. Processor 212 generates instructions for controlling each element of equipment recovery notification device 200, and outputs the instructions to each element.

Communicator 213 is a communication interface for equipment recovery notification device 200 to communicate with other devices. Communicator 213, for example, communicates with each of the plurality of units of manufacturing equipment 100 to receive the equipment name, type of component, stoppage timepoint, stoppage factor, operation timepoint, and work start timepoint. Communicator 213 transmits notification information generated by notifier 260 by communicating with terminal device 300.

Inputter 214 accepts operation inputs to equipment recovery notification device 200 from a worker or an administrator. Inputter 214 is realized, for example, by a mouse, a keyboard, or physical operation buttons, but may be a touch panel display and/or a voice input device.

Display 215 is for displaying, for example, details regarding the processing of equipment recovery notification device 200. Display 215 is implemented as a liquid crystal display or EL display device, for example.

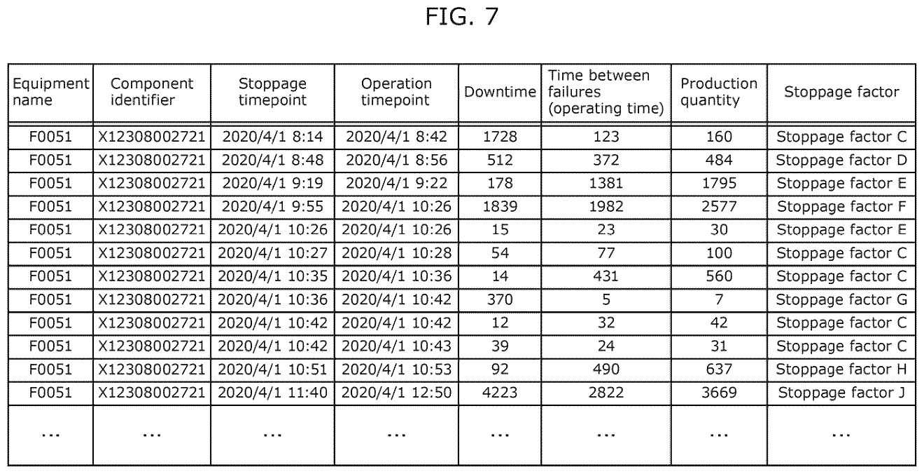

Equipment information storage unit 221 is memory for storing equipment information related to each unit of manufacturing equipment 100. The equipment information includes the stoppage timepoint, operation timepoint, stoppage factor, and time between failures for each unit of manufacturing equipment 100, including the current-process equipment and subsequent-process equipment. A specific example of the equipment information will be described later with reference to FIG. 7. Equipment information storage unit 221 is implemented as a non-volatile storage device such as an HDD or semiconductor memory.

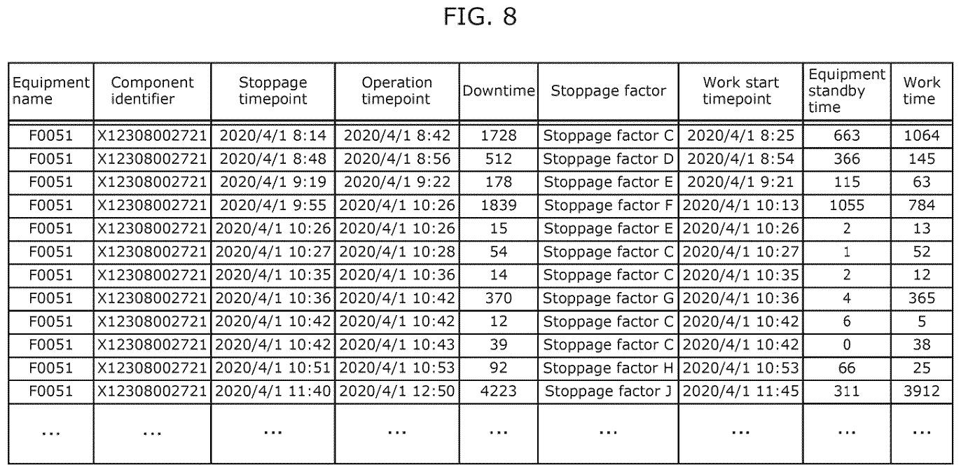

Work information storage unit 222 is memory for storing work information related to recovery work. The work information includes the stoppage factor, work time, and equipment standby time (idle time) for each unit of manufacturing equipment 100, including the current-process equipment and subsequent-process equipment. The work information may be stored for each worker. A specific example of the work information will be described later with reference to FIG. 8. Work information storage unit 222 is implemented as a non-volatile storage device such as an HDD or semiconductor memory.

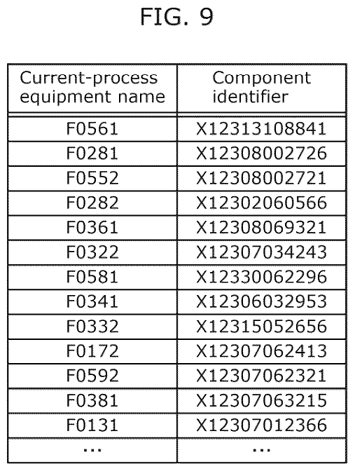

Component information storage unit 223 is memory for storing component information related to components produced by manufacturing equipment 100. The component information includes the type of components produced by each unit of manufacturing equipment 100 including the current-process equipment and subsequent-process equipment (component type information), the usage relationship of components (component-equipment correspondence information), the characteristics of components (component characteristics information), and the quantity of produced but unused components (unused quantity). The component information may include the production plan for each type of component in each process. A specific example of the component information will be described later with reference to FIG. 9 through FIG. 13. Component information storage unit 223 is implemented as a non-volatile storage device such as an HDD or semiconductor memory.

Model generator 230 generates a machine learning model by performing machine learning. The machine learning model is, for example, a regression model using Bayesian estimation. More specifically, model generator 230 generates a worker model of the recovery work for each worker. The worker model is, for example, a model that, when the worker name (identification number), stoppage factor, and work time of the worker are input as input data, estimates and outputs a work time distribution. Model generator 230 also generates a production capacity model for each unit of manufacturing equipment 100. The production capacity model is a model that, when the equipment name (identification number), type of component, stoppage factor, and operating time of the manufacturing equipment are input as input data, estimates and outputs an operating time distribution for each stoppage factor. The production capacity model may use the number of products produced as input data instead of the operating time to estimate and output a production quantity distribution for each stoppage factor.

Model generator 230 generates a simulation model for the subsequent process. The simulation model for the subsequent process is a regression model that is an integration of the worker model and the production capacity model. The simulation model for the subsequent process is a model that, when information related to the subsequent process is input as input data, estimates and outputs an operating time distribution or a production quantity distribution for each stoppage factor.

When two or more units of current-process equipment are stopped, estimator 240 estimates the productivity of subsequent-process equipment that use at least one of the components produced by the stopped current-process equipment. More specifically, estimator 240 estimates the productivity of subsequent-process equipment by utilizing the production capacity model or the subsequent process simulation model generated by model generator 230. A specific example of estimating the productivity will be given later.

Identifier 250 identifies one of the two or more units of stopped current-process equipment as the target equipment for recovery work based on the productivity estimated by estimator 240. More specifically, identifier 250 sets a priority for each of the two or more units of stopped current-process equipment, and identifies equipment for which the set priority is higher than a threshold value as the target equipment. The threshold value is a predetermined value, but is not limited thereto. The threshold value may be a priority set for one of the two or more units of stopped current-process equipment. Stated differently, identifier 250 may compare the priorities set for each of the two or more units of stopped current-process equipment and identify the equipment with a higher priority than others as the target equipment. For example, identifier 250 identifies the equipment with the highest set priority as the target equipment. A specific example of the priority setting process and the target equipment identification process will be described later.

Notifier 260 notifies of the target equipment identified by identifier 250. More specifically, notifier 260 creates notification information indicating the target equipment identified by identifier 250, and transmits the notification information to terminal device 300 carried by worker 2A. The notification information may include not only the target equipment, but also all of the stopped current-process equipment and the priority set for each.

For example, model generator 230, estimator 240, identifier 250, and notifier 260 are each realized as, but not limited to, a dedicated integrated circuit. The processing performed by each of model generator 230, estimator 240, identifier 250, and notifier 260 may be performed by processor 212 executing a predetermined program.

The configuration of equipment recovery notification device 200 is not limited to the example illustrated in FIG. 5. For example, it is acceptable if equipment recovery notification device 200 does not include model generator 230. In such cases, estimator 240 may estimate productivity based on statistical processing rather than machine learning.

### 1-2-3. Terminal Device

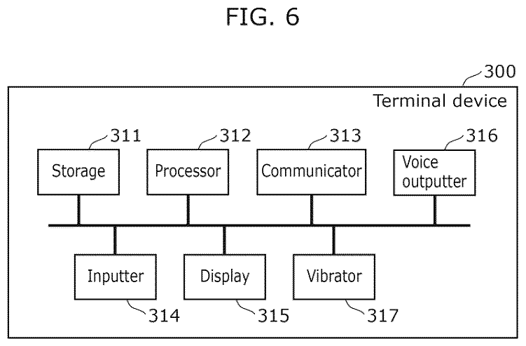

Next, the configuration of terminal device 300 will be described with reference to FIG. 6. FIG. 6 is a block diagram illustrating the configuration of terminal device 300 according to the present embodiment. Terminal device 300 is one example of a portable terminal possessed by worker 2A. Terminal device 300 is, for example, a smartphone or a tablet terminal.

As illustrated in FIG. 6, terminal device 300 includes storage 311, processor 312, communicator 313, inputter 314, display 315, voice outputter 316, and vibrator 317. The elements of terminal device 300 are communicably connected to each other.

Storage 311 is memory for storing information, data, and programs related to terminal device 300. Storage 311 stores the name of the worker (worker name) who possesses terminal device 300. The worker name is identification information uniquely assigned to each worker. For example, storage 311 stores the notification information transmitted from equipment recovery notification device 200. Storage 311 is implemented as a non-volatile storage device such as an HDD or semiconductor memory.

Processor 312 performs processing for controlling the overall operation of terminal device 300. Processor 312 is implemented, for example, as a processor. Processor 312 generates instructions for controlling each element of terminal device 300, and outputs the instructions to each element. For example, processor 312 generates a notification image based on the notification information obtained via communicator 313. Alternatively, processor 312 may generate audio including information included in the notification image. Processor 312 generates a control signal for vibrating vibrator 317 and outputs the generated control signal to vibrator 317.

Communicator 313 is a communication interface for terminal device 300 to communicate with other devices. Communicator 313, for example, communicates with equipment recovery notification device 200 to receive notification information generated by notifier 260. Communicator 313 may transmit information such as the worker name to equipment recovery notification device 200.

Inputter 314 accepts operation inputs to terminal device 300 from a worker or an administrator. Inputter 314 is realized, for example, by physical operation buttons, but may be a touch panel display and/or a voice input device.

Display 315 is for displaying, for example, notification images generated based on notification information transmitted from equipment recovery notification device 200. Display 315 is implemented as a liquid crystal display or EL display device, for example.

Voice outputter 316 is a loudspeaker for outputting, for example, voice generated based on notification information transmitted from equipment recovery notification device 200.

Vibrator 317 vibrates to vibrate terminal device 300. The vibration time, number of vibrations, and vibration strength of vibrator 317 may be variable.

The configuration of terminal device 300 is not limited to the example illustrated in FIG. 6. For example, terminal device 300 may include only one of display 315 or voice outputter 316. Terminal device 300 is not required to include vibrator 317.

### 1-3. Information Processed by Equipment Recovery Notification System

Next, information processed by equipment recovery notification system 10 according to the present embodiment will be described with reference to FIG. 7 through FIG. 15.

### 1-3-1. Equipment Information

FIG. 7 illustrates one example of equipment information. Equipment information includes information such as the operating and stoppage statuses of each unit of manufacturing equipment 100, as well as the stoppage factors thereof. Equipment information is information stored in equipment information storage 221 of equipment recovery notification device 200 based on information transmitted from each unit of manufacturing equipment 100. Equipment information storage 221 stores equipment information in a database format. One record (one row of data) is recorded for each stoppage. As illustrated in FIG. 7, the equipment information includes, for example, equipment names, component identifiers, stoppage timepoints, operation timepoints, downtime, time between failures, production quantities, and stoppage factors.

An equipment name is one example of equipment identification information, and is an identifier uniquely assigned to a unit of manufacturing equipment 100. A component identifier is one example of component identification information, and is an identifier uniquely assigned to a type of component produced by manufacturing equipment 100. The stoppage timepoint is the point in time at which the stoppage occurred. The operation timepoint is the point in time at which stopped manufacturing equipment 100 started operation, and is also referred to as the recovery timepoint.

Downtime is the time (duration) that manufacturing equipment 100 is stopped. Downtime is calculated by subtracting the stoppage timepoint from the operation timepoint. The time between failures corresponds to the operating time of manufacturing equipment 100, and is the time (duration) from the immediately preceding start of operation until stoppage. Time between failures is calculated by subtracting the immediately preceding operation timepoint from the stoppage timepoint.

Production quantity is the number of components produced by manufacturing equipment 100 while it was operating before it stopped. The stoppage factor is the factor that caused the stopped manufacturing equipment 100 to stop.

Equipment information is used as training data when generating the production capacity model for each unit of manufacturing equipment 100 (in the learning phase). Equipment information is also used as input data for the production capacity model of each unit of manufacturing equipment 100 when estimating the productivity of each unit of manufacturing equipment 100 (in the usage phase).

### 1-3-2. Work Information

FIG. 8 illustrates one example of work information. Work information is information related to recovery work performed for each unit of manufacturing equipment 100. Work information is information stored in work information storage 222 of equipment recovery notification device 200 based on information transmitted from each unit of manufacturing equipment 100 and/or terminal device 300. Work information storage 222 stores work information in a database format. One record is recorded for each instance of recovery work. As illustrated in FIG. 8, the work information includes, for example, equipment names, component identifiers, stoppage timepoints, operation timepoints, downtime, stoppage factors, work start timepoints, equipment standby times, and work times.

The equipment name, component identifier, stoppage timepoint, operation timepoint, downtime, and stoppage factor are the same as the equipment information illustrated in FIG. 7. Therefore, the work information may be integrated with the equipment information and stored in a database format.

The work start timepoint is the point in time at which the worker started the recovery work. Equipment standby time is the idle time from when manufacturing equipment 100 stops until recovery work is started. Equipment standby time is calculated by subtracting the stoppage timepoint from the work start timepoint. The work time is the time required by the worker for the recovery work. Work time is calculated by subtracting the work start timepoint from the operation timepoint. Alternatively, the work time may be calculated by subtracting the equipment standby time from the downtime.

Work information is used as training data when generating the worker model for each unit of manufacturing equipment 100 (in the learning phase). Work information is also used as input data for the worker model of each unit of manufacturing equipment 100 when estimating the productivity of each unit of manufacturing equipment 100 (in the usage phase).

### 1-3-3. Component Type Information

FIG. 9 illustrates one example of component type information. Component type information is information indicating the type of component produced by the current-process equipment. Component type information is information stored in component information storage 223 of equipment recovery notification device 200 based on information transmitted from each unit of manufacturing equipment 100 (specifically, the current-process equipment). Note that the component type information may be information generated based on a production plan input via inputter 214.

Component information storage 223 stores component type information in a database format. One record is recorded for each unit of manufacturing equipment 100. Note that when one unit of manufacturing equipment 100 produces a plurality of components, a plurality of records (equal to the number of components) are recorded for the one unit of manufacturing equipment 100.

As illustrated in FIG. 9, the component type information includes, for example, current-process equipment names and component identifiers. The current-process equipment name is identification information of the current-process equipment that produces the type of component indicated by the component identifier. The component identifier is an identifier uniquely assigned to a type of component.

The component type information is used in the process for estimating the productivity of the subsequent-process equipment. More specifically, the component type information is used in the process for estimating the required quantity of components, which is the number of components required by the subsequent-process equipment. Component type information is used as training data when generating the production capacity model for each unit of manufacturing equipment 100 (in the learning phase). Component type information is also used as input data for the production capacity model when estimating the productivity of each unit of manufacturing equipment 100 (in the usage phase).

### 1-3-4. Component-Equipment Correspondence Information

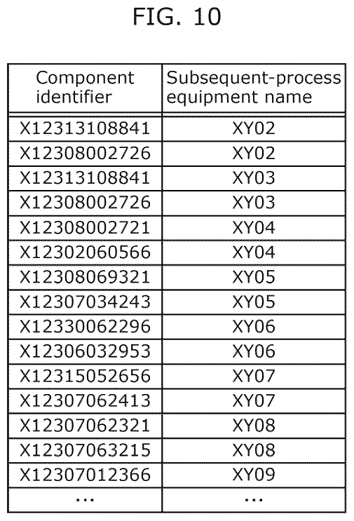

FIG. 10 illustrates one example of component-equipment correspondence information. Component-equipment correspondence information is correspondence information indicating, for each type of component, the subsequent-process equipment that uses the component produced by the current-process equipment. Component-equipment correspondence information is information stored in component information storage 223 of equipment recovery notification device 200 based on information transmitted from each unit of manufacturing equipment 100 (specifically, the subsequent-process equipment). Note that the component-equipment correspondence information may be information generated based on a production plan input via inputter 214.

Component information storage 223 stores component-equipment correspondence information in a database format. One record is recorded for each type of component. When one type of component is used by a plurality of units of subsequent-process equipment, a plurality of records (equal to the number of subsequent-process equipment that use the component) are recorded for the one type of component.

As illustrated in FIG. 10, the component-equipment correspondence information includes, for example, component identifiers and subsequent-process equipment names. The component identifier is an identifier uniquely assigned to a type of component. The subsequent-process equipment name is identification information of the subsequent-process equipment that uses the type of component indicated by the component identifier as material.

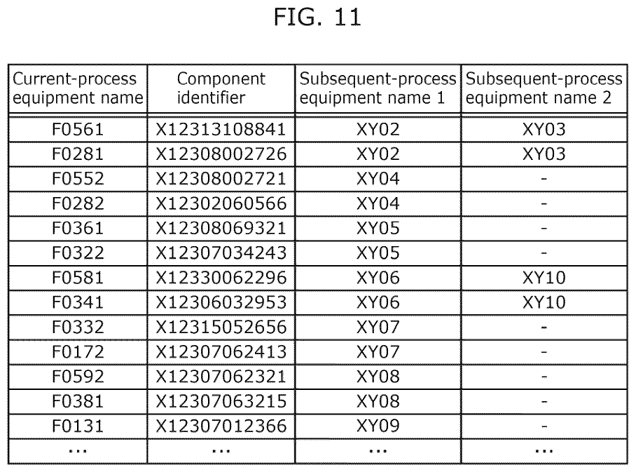

FIG. 11 illustrates another example of component-equipment correspondence information. The component-equipment correspondence information illustrated in FIG. 11 is a database that integrates the component type information illustrated in FIG. 9 and the component-equipment correspondence information illustrated in FIG. 10. For example, the record in the first row indicates that the type of component produced by the current-process equipment “F0561” is “X12313108841”, and this component is used by the two units of subsequent-process equipment “XY02” and “XY03”. Note that when one type of component is used by three or more units of subsequent-process equipment, the number of subsequent-process equipment items increases.

The component-equipment correspondence information is used in the process for estimating the productivity of the subsequent-process equipment. More specifically, the component-equipment correspondence information is used in the process for estimating the required quantity of components. Component-equipment correspondence information may be used as training data when generating the simulation model for the subsequent process of each unit of manufacturing equipment 100 (in the learning phase). Component-equipment correspondence information may also be used as input data for the simulation model for the subsequent process when estimating the productivity of each unit of manufacturing equipment 100 (in the usage phase).

### 1-3-5. Component Characteristics Information

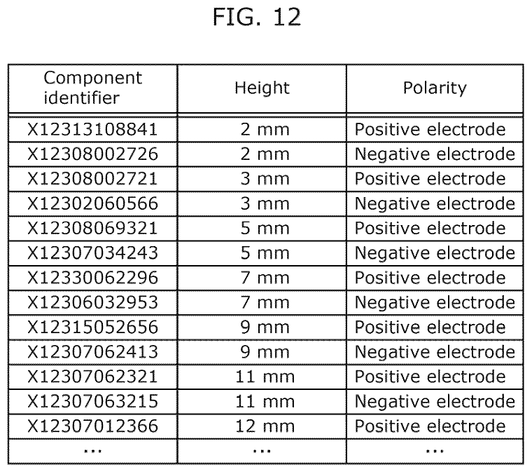

FIG. 12 illustrates one example of component characteristics information. Component characteristics information is information indicating characteristics of each type of component. Component characteristics information is information stored in component information storage 223 of equipment recovery notification device 200 based on information transmitted from each unit of manufacturing equipment 100. Note that the component characteristics information may be information generated based on a production plan input via inputter 214.

Component information storage 223 stores component characteristics information in a database format. One record is recorded for each type of component.

As illustrated in FIG. 12, the component characteristics information includes, for example, component identifiers, height, and polarity. Note that the component assumed here is an electrode used in an electrolytic capacitor. Height indicates the length of the electrode, and polarity indicates the polarity of the electrode. Components are not limited to capacitor electrodes, and the items of the component characteristics information can be appropriately changed according to the component.

### 1-3-6. Unused Component Information

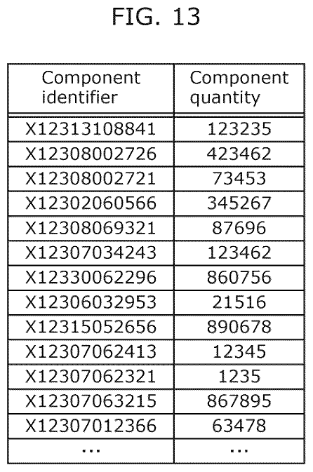

FIG. 13 illustrates one example of unused component information. Unused component information is information indicating unused quantities, which is the number of components already produced by the current-process equipment that have not yet been used. Unused component information is information stored in component informations storage 223 of equipment recovery notification device 200 based on information transmitted from each unit of manufacturing equipment 100. When a sensor is provided in the component storage area, the unused component information may be generated based on output from the sensor.

Component information storage 223 stores unused component information in a database format. One record is recorded for each type of component. Alternatively, one record may be recorded for each component storage area.

As illustrated in FIG. 13, the unused component information includes component identifiers and component quantities. The component identifier is an identifier uniquely assigned to a type of component. The component quantity indicates the unused quantity for each type of component. The unused quantity is the number of components that have been produced by the current-process equipment and have not yet been used by the subsequent-process equipment. The unused quantity is calculated by subtracting the usage quantity in the subsequent-process equipment from the production quantity of the current-process equipment.

The unused component information is used to estimate the productivity of the subsequent-process equipment. More specifically, the unused component information is used in the process for estimating the required quantity of components. Alternatively, unused component information may be used as training data when generating the simulation model for the subsequent process of each unit of manufacturing equipment 100 (in the learning phase). Unused component information may also be used as input data for the subsequent process simulation model when estimating the productivity of each unit of manufacturing equipment 100 (in the usage phase).

### 1-3-7. Capacity Information

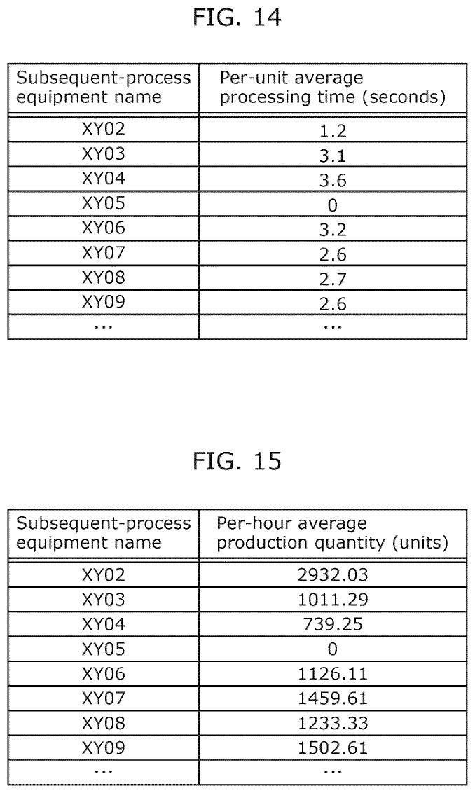

FIG. 14 illustrates one example of capacity information of subsequent-process equipment. Capacity information is information indicating the production capacity (for example, processing capacity) of the subsequent-process equipment. Capacity information is information generated based on information transmitted from each unit of manufacturing equipment 100 (specifically, the subsequent-process equipment). The capacity information is stored, for example, in equipment information storage 221. Equipment information storage 221 stores capacity information in a database format. One record is recorded for each unit of manufacturing equipment 100.

As illustrated in FIG. 14, the capacity information includes subsequent-process equipment names and per-unit average processing times (in seconds). The per-unit average processing time is the average time required for the subsequent-process equipment to produce (process) one component. For example, the average processing time is calculated by dividing the production quantity produced by the subsequent-process equipment over a certain period, by that period.

The capacity information may include, instead of or in addition to the average processing time, statistical information such as variance, or a probability distribution and its parameters. The capacity information may be empirical distribution information of actual data aggregated on the operating status (downtime and time between failures) of the subsequent-process equipment.

Alternatively, as illustrated in FIG. 15, the capacity information may include per-hour average production quantities. FIG. 15 illustrates one example of capacity information of subsequent-process equipment. The capacity information may include, instead of or in addition to the average production quantity, statistical information such as variance, or a probability distribution and its parameters. The capacity information may include empirical distribution information of actual data aggregated on the production quantity of the subsequent-process equipment.

The capacity information may include stoppage factors of the subsequent-process equipment. By considering the stoppage factor, when the subsequent-process equipment is malfunctioning, the average processing time or the average production quantity may be set to 0 regardless of actual data.

The capacity information is used to estimate the productivity of the subsequent-process equipment. More specifically, the capacity information is used in the process for estimating the required quantity of components. Alternatively, capacity information may be used as training data when generating the simulation model for the subsequent process of each unit of manufacturing equipment 100 (in the learning phase). Capacity information may also be used as input data for the subsequent process simulation model when estimating the productivity of each unit of manufacturing equipment 100 (in the usage phase).

### 1-4. Operations

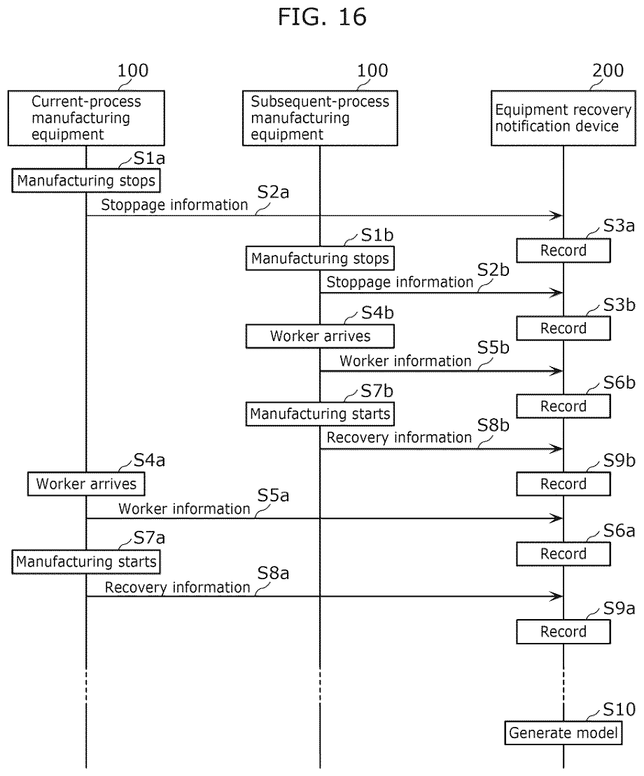

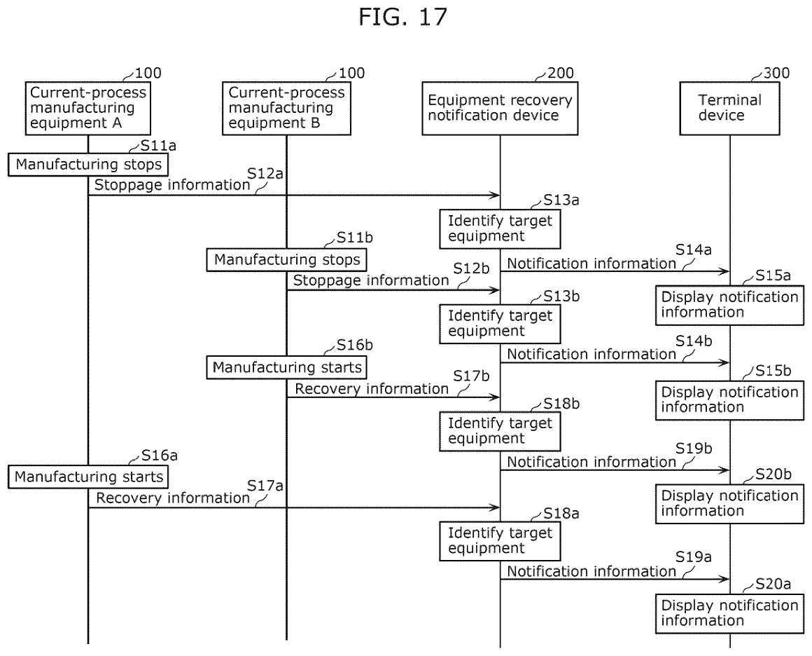

Next, operations performed by equipment recovery notification system 10 according to the present embodiment will be described. The operations performed by equipment recovery notification system 10 according to the present embodiment include two main processes: a learning phase and a usage phase. First, an overview of the processing in each of the learning phase and usage phase will be described using the sequence diagrams of FIG. 16 and FIG. 17.

### 1-4-1. Learning Phase

First, an overview of the processing in the learning phase will be described with reference to FIG. 16. FIG. 16 is a sequence diagram illustrating a process for recording information and generating a model (learning phase) performed by equipment recovery notification system 10 according to the present embodiment.

In FIG. 16, a single unit of manufacturing equipment 100 (current-process equipment) of the current process and a single unit of manufacturing equipment 100 (subsequent-process equipment) of the subsequent process are each representatively illustrated. When there are a plurality of units of current-process equipment and/or a plurality of units of subsequent-process equipment, in either case, the operations described below are performed.

As illustrated in FIG. 16, when a manufacturing stoppage occurs in current-process equipment (Sla), the current-process equipment transmits stoppage information related to the stoppage of the current-process equipment to the equipment recovery notification device (S2a). Equipment recovery notification device 200 receives the stoppage information transmitted from the current-process equipment and records the received stoppage information (S3a).

When a manufacturing stoppage occurs in subsequent-process equipment (S1b), similar to the case of the current-process equipment, the subsequent-process equipment transmits stoppage information related to the stoppage of the subsequent-process equipment to the equipment recovery notification device (S2b). Equipment recovery notification device 200 receives the stoppage information transmitted from the subsequent-process equipment and records the received stoppage information (S3b).

Although this example shows a case where subsequent-process equipment stops after current-process equipment has stopped, the present disclosure is not limited to this case. There are cases where current-process equipment stops after subsequent-process equipment has stopped, and there are also cases where current-process equipment and subsequent-process equipment stop substantially simultaneously. In any case, transmission of stoppage information and recording of information are performed.

When a worker arrives at the subsequent-process equipment (S4b), the subsequent-process equipment transmits worker information related to the worker who is to perform the recovery work for the subsequent-process equipment (S5b). Equipment recovery notification device 200 records the transmitted worker information (S6b).

When the recovery work is completed and the subsequent-process equipment starts manufacturing (S7b), the subsequent-process equipment transmits recovery information related to the recovery of (the start of manufacturing by) the subsequent-process equipment (S8b). Equipment recovery notification device 200 records the transmitted recovery information (S9b).

Furthermore, when a worker arrives at the current-process equipment (S4a), the current-process equipment transmits worker information related to the worker who is to perform the recovery work for the current-process equipment (S5a). Equipment recovery notification device 200 records the transmitted worker information (S6a). When the recovery work is completed and the current-process equipment starts manufacturing (S7a), the current-process equipment transmits recovery information related to the recovery of (the start of manufacturing by) the current-process equipment (S8a). Equipment recovery notification device 200 records the transmitted recovery information (S9a).

Although this example shows a case where recovery work for subsequent-process equipment is performed before current-process equipment, the present disclosure is not limited to this case. There are also cases where recovery work for current-process equipment is performed before subsequent-process equipment. In cases in which there are a plurality of workers, there may be instances where recovery work for current-process equipment and recovery work for subsequent-process equipment are performed simultaneously. In any case, the transmission of worker information and recovery information and the recording of information are performed.

As described above, each time an equipment stoppage occurs, each time a worker arrives (each time recovery work is started), and each time equipment starts operation, equipment recovery notification device 200 obtains and records information. This allows the equipment information illustrated in FIG. 7 and the work information illustrated in FIG. 8 to each be stored in a database format.

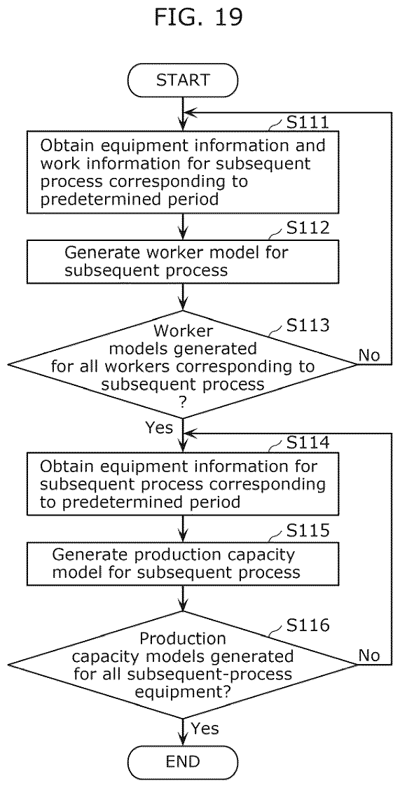

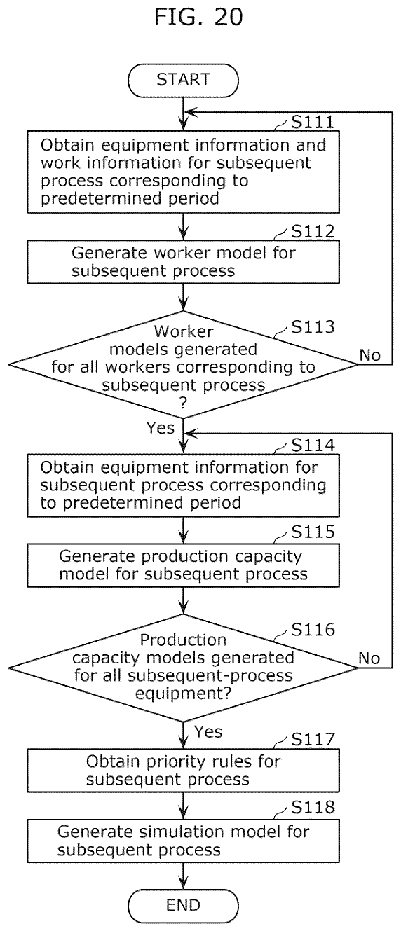

Using information from a certain period of time, model generator 230 of equipment recovery notification device 200 generates a machine learning model by performing machine learning (S10). A specific example of generating the machine learning model will be described later with reference to FIG. 19 and FIG. 20.

### 1-4-2. Usage Phase

Next, an overview of the processing in the usage phase will be described with reference to FIG. 17. FIG. 17 is a sequence diagram illustrating a process for equipment recovery notification (usage phase) performed by equipment recovery notification system 10 according to the present embodiment.

In FIG. 17, two units of manufacturing equipment 100 among the plurality of units of manufacturing equipment 100 corresponding to the current process (i.e., two units of current-process equipment) are representatively illustrated. When there are a plurality of units of current-process equipment, in either case, the operations described below are performed.

As illustrated in FIG. 17, when a manufacturing stoppage occurs in current-process manufacturing equipment 100 (exemplified here as current-process equipment A) (S11a), current-process equipment A transmits stoppage information related to current-process equipment A to equipment recovery notification device 200 (S12a). Since current-process equipment A has stopped and has been newly added as a candidate for recovery work, equipment recovery notification device 200 identifies target equipment for recovery work (S13a), and transmits notification information including identification information of the identified target equipment to terminal device 300 (S14a). Terminal device 300 displays the notification information transmitted from equipment recovery notification device 200 (S15a). Note that the target equipment indicated by the notification information at this time is not necessarily current-process equipment A, and may be current-process equipment other than current-process equipment A.

When a manufacturing stoppage occurs in current-process manufacturing equipment 100 other than current-process equipment A (exemplified here as current-process equipment B) (S11b), current-process equipment B transmits stoppage information related to current-process equipment B to equipment recovery notification device 200 (S12b). Since current-process equipment B has stopped and has been newly added as a candidate for recovery work, equipment recovery notification device 200 identifies target equipment for recovery work (S13b), and transmits notification information including identification information of the identified target equipment to terminal device 300 (S14b). Terminal device 300 displays the notification information transmitted from equipment recovery notification device 200 (S15b). Here, it is assumed that the target equipment indicated by the notification information at this time is current-process equipment B. In this case, the worker performs recovery work for current-process equipment B.

When current-process equipment B starts manufacturing after the recovery work is performed (S16b), current-process equipment B transmits recovery information related to the recovery of (the start of manufacturing by) current-process equipment B (S17b). Since current-process equipment B has recovered and has been removed as a candidate for recovery work, equipment recovery notification device 200 identifies target equipment for recovery work (S18b), and transmits notification information including identification information of the identified target equipment to terminal device 300 (S19b). Terminal device 300 displays the notification information transmitted from equipment recovery notification device 200 (S20b). Here, it is assumed that the target equipment indicated by the notification information at this time is current-process equipment A. In this case, the worker performs recovery work for current-process equipment A.

When current-process equipment A starts manufacturing after the recovery work is performed (S16a), current-process equipment A transmits recovery information related to the recovery of (the start of manufacturing by) current-process equipment A (S17a). Since current-process equipment A has recovered and has been removed as a candidate for recovery work, equipment recovery notification device 200 identifies target equipment for recovery work (S18a), and transmits notification information including identification information of the identified target equipment to terminal device 300 (S19a). Terminal device 300 displays the notification information transmitted from equipment recovery notification device 200 (S20a).

As described above, with equipment recovery notification system 10 according to the present embodiment, each time a unit of the current-process equipment stops, and each time stopped current-process equipment recovers, the processes of identifying target equipment for recovery work and transmitting a notification thereof are performed. Stated differently, equipment recovery notification system 10 performs the processes of identifying target equipment and transmitting a notification thereof each time there is an increase or decrease in the number of units of stopped manufacturing equipment 100. Since this makes it possible to notify a worker of the appropriate target equipment on which recovery work should be performed according to changes in the operating status of the production system, the system excels in real-time performance, and can support the improvement of productivity.

### 1-5. Specific Processing

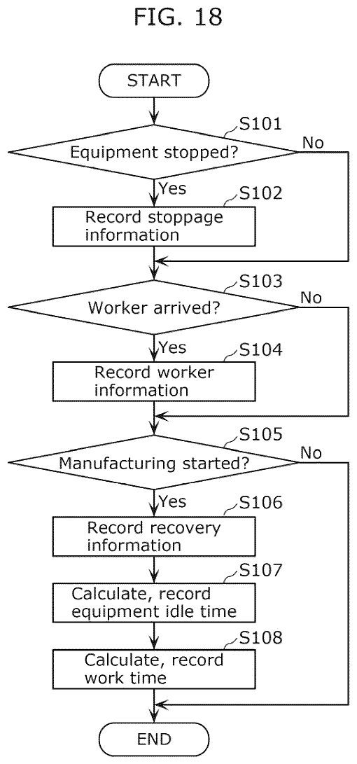

Next, specific processing performed by equipment recovery notification system 10 according to the present embodiment will be described in greater detail with reference to FIG. 18 through FIG. 23.

### 1-5-1. Process for Recording Information

First, the process for recording information (learning phase) performed by equipment recovery notification system 10 will be described with reference to FIG. 18. FIG. 18 is a flowchart illustrating a process for recording information that is performed by equipment recovery notification system 10 according to the present embodiment. FIG. 18 corresponds to steps Sa to S9a and S1b to S9b in the sequence diagram illustrated in FIG. 16.

First, when a stoppage of manufacturing equipment 100 occurs (Yes in S101), equipment recovery notification device 200 receives the stoppage information transmitted from manufacturing equipment 100 and records it in equipment information storage 221 (S102). The stoppage information includes a stoppage notification indicating that manufacturing equipment 100 has stopped, and includes the stoppage and operating statuses of manufacturing equipment 100, as well as the stoppage factor and the type of component. The stoppage and operating statuses include, for example, the equipment name, stoppage timepoint, production quantity, and operation timepoint.

More specifically, when a stoppage of manufacturing equipment 100 occurs, in manufacturing equipment 100, stoppage timepoint identifier 132 identifies the stoppage timepoint, and stoppage factor identifier 141 identifies the stoppage factor. Processor 112 calculates the production quantity of components produced until the stoppage, specifically, the number of components output by product outputter 124. Processor 112 also reads out the equipment name stored in storage 111 and the component identifier of the component being produced. Processor 112 transmits stoppage information including the stoppage timepoint, stoppage factor, production quantity, equipment name, and component identifier to equipment recovery notification device 200 via communicator 113. In equipment recovery notification device 200, stoppage information received via communicator 213 is recorded in equipment information storage 221. Here, processor 212 of equipment recovery notification device 200 calculates the downtime and time between failures, and records them in equipment information storage 221.

When manufacturing equipment 100 does not stop (No in S101), the process of recording stoppage information (S102) is omitted.

Next, when a worker arrives at stopped manufacturing equipment 100 (Yes in S103), equipment recovery notification device 200 receives the worker information transmitted from manufacturing equipment 100 or terminal device 300 and records it in work information storage 222 (S104). The worker information includes the equipment name of manufacturing equipment 100 subject to the recovery work, the name of the worker who performs the recovery work (worker name), and the timepoint at which the worker started the recovery work (work start timepoint).

More specifically, when a worker arrives, the worker inputs, via inputter 114 of manufacturing equipment 100, that they have arrived, i.e., that they have started the recovery work. Processor 112 determines the timepoint input by inputter 114 as the work start timepoint. Processor 112 also reads out the equipment name stored in storage 111. Processor 112 transmits the work start timepoint and equipment name to equipment recovery notification device 200 via communicator 113. Processor 312 of terminal device 300 also reads out the worker name from storage 311 and transmits the read worker name to equipment recovery notification device 200 via communicator 313. Note that the input of the start of recovery work may be performed via inputter 314 of terminal device 300 carried by the worker, and the work start timepoint may be transmitted from terminal device 300.

When a worker does not arrive at manufacturing equipment 100 (No in S103), the process of recording worker information (S104) is omitted.

Next, when stopped manufacturing equipment 100 starts manufacturing (Yes in S105), equipment recovery notification device 200 receives the recovery information transmitted from manufacturing equipment 100 and records it in work information storage 222 (S106). The recovery information includes a recovery notification indicating that manufacturing equipment 100 has recovered, as well as the operation timepoint (recovery timepoint) and equipment name of manufacturing equipment 100.

More specifically, when manufacturing equipment 100 starts manufacturing, in manufacturing equipment 100, operation timepoint identifier 131 identifies the operation timepoint. Processor 112 reads out the equipment name stored in storage 111, and transmits recovery information including the read equipment name and operation timepoint to equipment recovery notification device 200 via communicator 113. In equipment recovery notification device 200, recovery information received via communicator 213 is recorded in work information storage 222 and equipment information storage 221.

Next, processor 212 of equipment recovery notification device 200 calculates the idle time (equipment standby time) of manufacturing equipment 100 based on the obtained worker information and recovery information, and records the calculated idle time in work information storage 222 (S107). Processor 212 calculates the idle time by subtracting the stoppage timepoint from the work start timepoint.

Next, processor 212 of equipment recovery notification device 200 calculates the work time of manufacturing equipment 100 based on the obtained worker information and recovery information, and records the calculated work time in work information storage 222 (S108). Processor 212 calculates the work time by subtracting the work start timepoint from the operation timepoint.

The above processing is performed each time manufacturing equipment 100 stops, as illustrated in FIG. 16. With this, stoppage information and recovery information are accumulated in equipment information storage 221 of equipment recovery notification device 200, and a database of the equipment information illustrated in FIG. 7 is constructed. Additionally, worker information and recovery information are accumulated in work information storage 222 of equipment recovery notification device 200, and a database of the work information illustrated in FIG. 8 is constructed.

### 1-5-2. Model Generation Process

Next, the process for generating models (learning phase) performed by equipment recovery notification system 10 will be described with reference to FIG. 19. FIG. 19 is a flowchart illustrating a process for generating models performed by equipment recovery notification system 10 according to the present embodiment. FIG. 19 corresponds to step S10 in the sequence diagram illustrated in FIG. 16.

First, model generator 230 of equipment recovery notification device 200 obtains the equipment information and work information for the subsequent process corresponding to a predetermined period (S111). More specifically, model generator 230 reads out the equipment information related to the subsequent-process equipment for a predetermined period from equipment information storage 221, and reads out the work information related to the subsequent-process equipment for the predetermined period from work information storage 222.

Note that the predetermined period is a relatively long period such as one day, one week, or one month, but is not particularly limited. Extending the period can improve the accuracy of machine learning. On the other hand, shortening the period reduces the processing time required for machine learning.

Model generator 230 generates a worker model for the subsequent process based on the obtained information (S112). The worker model for the subsequent process is generated for each worker, and is a model for estimating a work time distribution for a case in which the corresponding worker performs recovery work on the subsequent-process equipment.

For example, model generator 230 generates a worker model by performing machine learning using, as input data, the work time of recovery work performed by the worker, as well as the stoppage factor, equipment name, and type of component of the subsequent-process equipment subject to the recovery work. The worker model is, for example, a model that, when the stoppage factor, equipment name, and type of component of the subsequent-process equipment are input, estimates and outputs a work time distribution.

Model generator 230 repeatedly performs steps S111 and S112 until worker models are generated for all workers who perform recovery work on the plurality of units of subsequent-process equipment (No in S113).

After worker models are generated for all workers corresponding to the subsequent process (Yes in S113), model generator 230 obtains the equipment information for the subsequent process corresponding to a predetermined period (S114). More specifically, model generator 230 reads out the equipment information related to the subsequent-process equipment for a predetermined period from equipment information storage 221.

Model generator 230 generates a production capacity model for the subsequent-process equipment based on the obtained information (S115). The production capacity model is generated for each unit of subsequent-process equipment, and is a model for estimating the productivity of the corresponding subsequent-process equipment.

For example, model generator 230 generates a production capacity model by performing machine learning using, as input data, the operation timepoint, stoppage timepoint, equipment name, stoppage factor, type of component, and production quantity of a given unit of subsequent-process equipment. The production capacity model is, for example, a model that, when the operation timepoint, stoppage timepoint, equipment name, stoppage factor, and type of component of the subsequent-process equipment are input, outputs an operating time distribution or a production quantity distribution.

Model generator 230 repeatedly performs steps S114 and S115 until production capacity models are generated for all units of subsequent-process equipment (No in S116). When production capacity models have been generated for all units of subsequent-process equipment (Yes in S116), the process of the learning phase ends.

Note that although FIG. 19 illustrates an example in which the production capacity model is generated after generating the worker model, the present disclosure is not limited to this example. For example, the worker model may be generated after generating the production capacity model. Alternatively, the processes of generating the two models may be performed concurrently, i.e., in parallel.

Model generator 230 may generate a simulation model for the subsequent process after integrating the two models. FIG. 20 is a flowchart illustrating another example of a process for generating models for a subsequent process performed by equipment recovery notification system 10 according to the present embodiment.

In the example illustrated in FIG. 20, the processes of steps S111 to S116 are the same as those in FIG. 19. After worker models for all workers in the subsequent process and production capacity models for all subsequent-process equipment have been generated (Yes in S116), model generator 230 obtains priority rules for the subsequent process (S117). A priority rule is information indicating conditions for setting the priority of recovery work. For example, the priority is set based on the productivity of the subsequent-process equipment. More specifically, the priority is set based on the quantity of components required by the subsequent-process equipment over a certain period (“required quantity of components”). For example, a priority rule defines a priority setting method and a method for calculating the required quantity of components.

Model generator 230 generates a simulation model for the subsequent process by integrating the worker models and the production capacity models based on the priority rule (S118). The simulation model for the subsequent process is, for example, a model that, when information related to each unit of stopped equipment and the workers performing recovery work is input, sets and outputs a priority for each of the plurality of units of stopped manufacturing equipment 100 based on the priority rule.

### 1-5-3. Equipment Recovery Notification Process

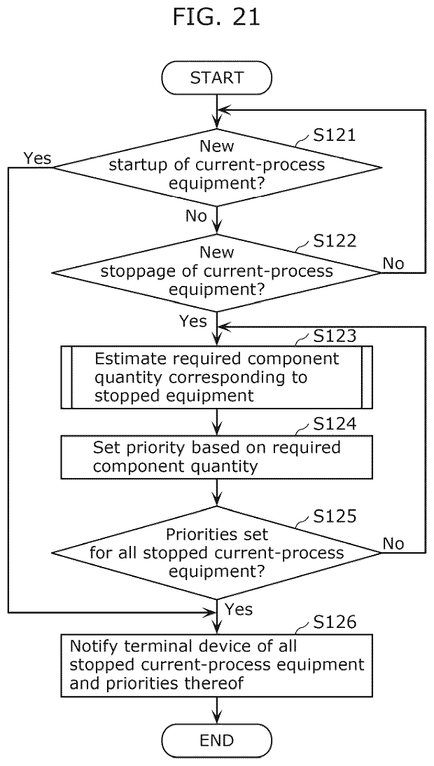

Next, the equipment recovery notification process (usage phase) performed by equipment recovery notification system 10 will be described with reference to FIG. 21. FIG. 21 is a flowchart illustrating an equipment recovery notification process performed by equipment recovery notification system 10 according to the present embodiment. FIG. 21 corresponds to each step in the sequence diagram illustrated in FIG. 17.

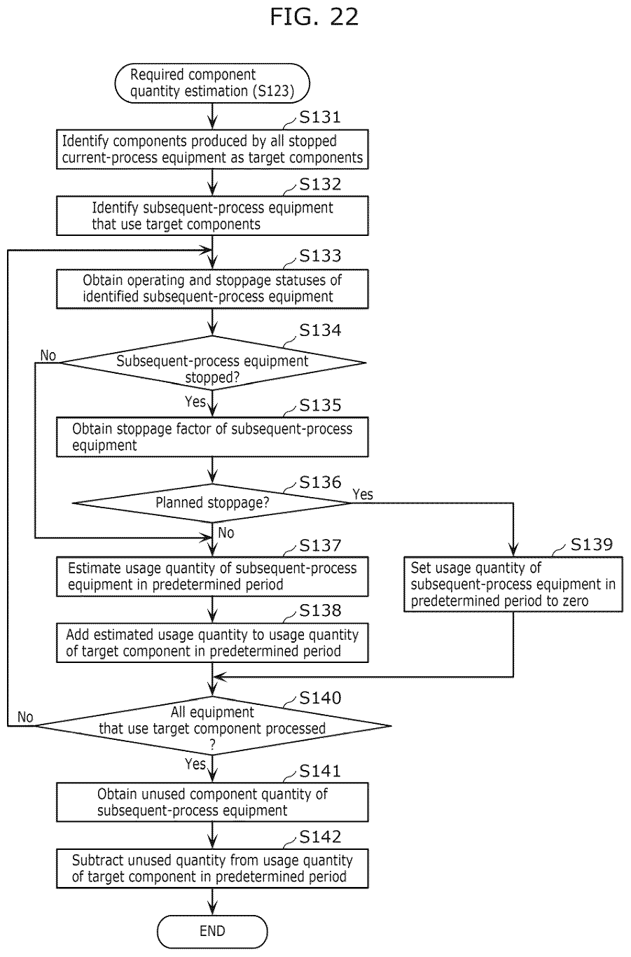

As illustrated in FIG. 21, equipment recovery notification device 200 stands by until a new startup (recovery) of the current-process equipment occurs or a new stoppage of the current-process equipment occurs (No in S121 and No in S122). When a new stoppage of the current-process equipment occurs (Yes in S122), estimator 240 of equipment recovery notification device 200 estimates the required quantity of components (S123). The required quantity of components is the number of components produced by the corresponding current-process equipment that are required in a predetermined period by the subsequent-process equipment. The required quantity of components is one example of the productivity of the subsequent-process equipment. A specific example of the estimation process for the required quantity of components will be described later with reference to FIG. 22.

Next, identifier 250 of equipment recovery notification device 200 sets a priority for the recovery work based on the estimated required quantity of components (S124). More specifically, the greater the required quantity of components, the higher identifier 250 sets the priority. For example, identifier 250 compares the estimated required quantity of components for other units of stopped current-process equipment with the currently estimated required quantity of components, and sets a higher priority for equipment with a greater required quantity of components than for equipment with a smaller required quantity of components. Identifier 250 may also set the required quantity of components itself as the priority. Steps S123 and S124 are repeated until the priorities are set for all stopped current-process equipment (No in S125).

After priorities are set for all stopped current-process equipment (Yes in S125), notifier 260 notifies terminal device 300, via communicator 213, of all the stopped current-process equipment and their priorities (S126). This notification is also performed when a new startup of current-process equipment occurs (Yes in S121).

Stated differently, when the number of stopped current-process equipment decreases as a result of recovery work being performed, a notification is transmitted excluding the current-process equipment that started operating.

### 1-5-4. Process for Estimating Required Quantity of Components

Next, the process for estimating the required quantity of components (S123) will be described with reference to FIG. 22. FIG. 22 is a flowchart illustrating the process for estimating a required quantity of components (S123) performed by equipment recovery notification system 10 according to the present embodiment. Hereinafter, the correspondence relationship between current-process equipment and subsequent-process equipment illustrated in FIG. 2 will be described by way of example.

As illustrated in FIG. 22, estimator 240 of equipment recovery notification device 200 identifies the component produced by the stopped current-process equipment as a target component (S131). More specifically, estimator 240 identifies the target component based on the component type information included in the stoppage information transmitted from the current-process equipment. For example, when equipment B in FIG. 2 is stopped, component “b” is identified as the target component.

Next, estimator 240 identifies subsequent-process equipment that use the target component (S132). More specifically, estimator 240 identifies the subsequent-process equipment by referring to the component-equipment correspondence information (for example, FIG. 10 or FIG. 11) stored in component information storage 223 based on the component type information included in the stoppage information transmitted from the current-process equipment. For example, equipment X is identified as subsequent-process equipment that uses component “b” produced by equipment B in FIG. 2. Two units of equipment, namely equipment Y and Z, are identified as subsequent-process equipment that use component “d” produced by equipment D in FIG. 2.

Next, estimator 240 obtains the operating and stoppage status of the identified subsequent-process equipment (S133). More specifically, based on the equipment name of the identified subsequent-process equipment, estimator 240 obtains information indicating whether the identified subsequent-process equipment is operating or stopped by referring to the equipment information stored in equipment information storage 221. Alternatively, estimator 240 may obtain the operating and stoppage status by communicating with identified subsequent-process equipment via communicator 213.

If the subsequent-process equipment is stopped (Yes in S134), estimator 240 obtains the stoppage factor of the subsequent-process equipment (S135). More specifically, based on the equipment name of the identified subsequent-process equipment, estimator 240 obtains the stoppage factor of the identified subsequent-process equipment by referring to the equipment information stored in equipment information storage 221.

If the stoppage factor is not a planned stoppage (No in S136), or if the subsequent-process equipment is not stopped (No in S134), estimator 240 estimates the number of components to be used by (i.e., the usage quantity of) the subsequent-process equipment in a predetermined period (S137). Here, the predetermined period is shorter than the period of data used for generating the machine learning model, and is a relatively short period such as several seconds, several minutes, or several tens of minutes. Estimator 240 estimates the usage quantity using a production capacity model of the subsequent-process equipment.

Next, estimator 240 adds the estimated usage quantity to the usage quantity of the target component in the predetermined period (S138). This addition is omitted when the target component is used by only a single unit of subsequent-process equipment.

If the stoppage factor is a planned stoppage (Yes in S136), estimator 240 sets the usage quantity of the target component by the target subsequent-process equipment to 0 (S139). For example, because equipment X in FIG. 2 is in a planned stoppage, the usage quantity of component “b” by equipment X is set to 0. Note that estimator 240 is not limited to setting the usage quantity of the target component to 0 for just planned stoppages; estimator 240 may set the usage quantity of the target component to 0 when predetermined conditions are satisfied. Predetermined conditions are, for example, that the equipment is under maintenance, is malfunctioning, or has not been operating for at least a predetermined long period of time.

Steps S133 to S139 are repeated for all subsequent-process equipment that use the target component (No in S140). When a plurality of units of subsequent-process equipment use the target component, by repeating the addition (S138), the usage quantity of the target component can be appropriately calculated in accordance with the actual circumstances. For example, in the case of component “d” in FIG. 2, a value obtained by adding the usage quantity by equipment Y and the usage quantity by equipment Z is calculated as the usage quantity of the target component.

After the calculation of the component usage quantity for all subsequent-process equipment that use the target component has ended (Yes in S140), estimator 240 obtains the unused component quantity of the subsequent-process equipment (S141). More specifically, based on the type of the target component, estimator 240 obtains the unused quantity by referring to the unused component information (for example, FIG. 13). For example, in the case of component “d” illustrated in FIG. 2, the unused quantity is one unit.

Next, estimator 240 calculates the required quantity of components for the target component by subtracting the unused quantity from the usage quantity of the target component (S142).

The above processing is performed for all stopped current-process equipment, as illustrated in step S125 of FIG. 21. In the example of FIG. 2, the required quantity of components produced by each of current-process equipment B, D, and E, is calculated.

Hereinafter, an example will be given in which the usage quantity of components by each unit of subsequent-process equipment is estimated as follows.
Usage quantity of component “a” by equipment X=0
Usage quantity of component “b” by equipment X=0
Usage quantity of component “c” by equipment Y=5
Usage quantity of component “d” by equipment Y=5
Usage quantity of component “c” by equipment Z=5
Usage quantity of component “d” by equipment Z=5
Usage quantity of component “e” by equipment W=5
Usage quantity of component “f” by equipment W=5

In this case, the required quantity of components “b”, “d”, and “e” produced by current-process equipment B, D, and E, respectively, is as follows.

(Required quantity of component“b”)=(Usage quantity of component“b” by equipment X:0)−(Unused quantity of component“b”:4)=−4

(Required quantity of component“d”)=(Usage quantity of component“d” by equipment Y:5)+(Usage quantity of component“c” by equipment Z:5)−(Unused quantity of component“c”:1)=9

(Required quantity of component“e”)=(Usage quantity of component“e” by equipment W:5)−(Unused quantity of component“e”:1)=4

In the present embodiment, the greater the required quantity of components, the higher the priority is set. Accordingly, in the above example, the priority of subsequent-process equipment D that produces component “d”, which has the greatest required quantity of components, is set the highest.

For example, as illustrated in FIG. 12, in the manufacture of capacitors, if there is an insufficient quantity of the positive electrode and negative electrode manufactured in the current process, production in the subsequent process cannot be performed. Therefore, even if the current-process equipment that produces the negative electrode increases production of negative electrodes to boost productivity, it wont lead to improved productivity because the shortage of positive electrodes prevents production in the subsequent process. In equipment recovery notification system 10 according to the present embodiment, since the priority of the current-process equipment is determined taking into consideration the productivity of the subsequent-process equipment (specifically, the required quantity of components in the subsequent-process equipment), productivity can be improved.

### 1-5-5. Display Process

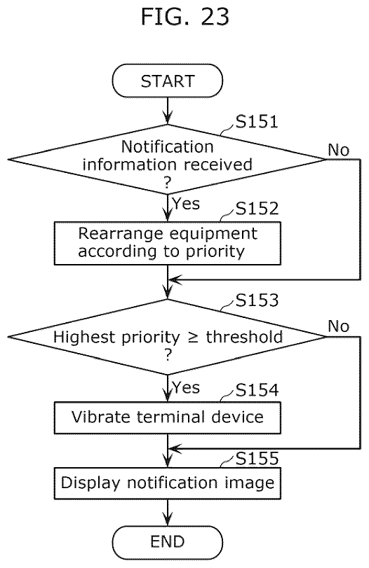

Next, the process for displaying a notification image that is performed by terminal device 300 will be described with reference to FIG. 23. FIG. 23 is a flowchart illustrating a process for displaying a notification image that is performed by equipment recovery notification system 10 according to the present embodiment.

As illustrated in FIG. 23, when processor 312 of terminal device 300 obtains notification information from equipment recovery notification system 10 via communicator 313 (Yes in S151), processor 312 rearranges the equipment names of the stopped current-process equipment according to the priority included in the notification information (S152). More specifically, processor 312 rearranges the equipment names of the current-process equipment in order from the equipment with the highest set priority.

After the rearrangement is completed, or when new notification information is not obtained (No in S151), processor 312 determines whether the highest priority is greater than or equal to a threshold value (S153). The threshold value is set according to the importance of the recovery work.

If the highest priority is greater than or equal to the threshold value (Yes in S153), processor 312 controls vibrator 317 to vibrate terminal device 300 (S154). Vibrating terminal device 300 ensures that workers can be alerted to notifications even while performing recovery work on other equipment. For example, terminal device 300 vibrates when the urgency of the recovery work is high enough that the recovery work should be performed first, even if it means stopping other recovery work. Instead of or in addition to vibration, processor 312 may output a buzzer or alarm sound or the like from voice outputter 316.

After vibrating, or if the highest priority is less than the threshold value (No in S153), processor 312 displays the notification image on display 315 (S155). For example, in the notification image, the equipment names representing the respective units of stopped current-process equipment are arranged in descending order of priority of the equipment the names correspond to. Instead of or in addition to displaying the notification image, processor 312 may output from voice outputter 316 a voice that reads out the equipment name with the highest priority, or a voice that reads out the equipment names in descending order of priority. In such cases, whether to output voice or not, and if so the volume level thereof, may be changed according to the level of priority. The level of priority may also be expressed by differences in the manner of vibration, such as the number of vibrations or the length of vibration time.

As described above, in terminal device 300, each time notification information is obtained, a notification image is displayed. Stated differently, the notification information is transmitted each time there is an increase or decrease in the stoppage of the current-process equipment, and therefore the notification image is updated each time there is an increase or decrease in the stoppage of the current-process equipment. Since this makes it possible to transmit a notification of the appropriate target equipment according to changes in the situation, the system excels in real-time performance, and can support the further improvement of productivity.

### Embodiment 2

Next, Embodiment 2 will be described.

Embodiment 2 differs from Embodiment 1 in that it further utilizes the productivity of the current process. Hereinafter, the explanation will focus on the differences from Embodiment 1, and description of points in common will be omitted or simplified.

The equipment recovery notification system according to Embodiment 2 has the same configuration as in Embodiment 1. Therefore, hereinafter, operations performed by the equipment recovery notification system (equipment recovery notification method) according to the present embodiment will be described with reference to the configurations of the respective devices illustrated in FIG. 3 through FIG. 6.

### 2. Operations

Similar to Embodiment 1, the operations performed by equipment recovery notification system 10 according to the present embodiment include two main processes: a learning phase and a usage phase. An overview of each phase is as illustrated in FIG. 16 and FIG. 17.

### 2-1. Model Generation Process

In the present embodiment, the process for generating a machine learning model (step S10 in FIG. 16) in the learning phase differs from that of Embodiment 1. More specifically, in generating the machine learning model, as illustrated in FIG. 19, in addition to generating the worker model and production capacity model for the subsequent process, the worker model and production capacity model for the current process are generated.

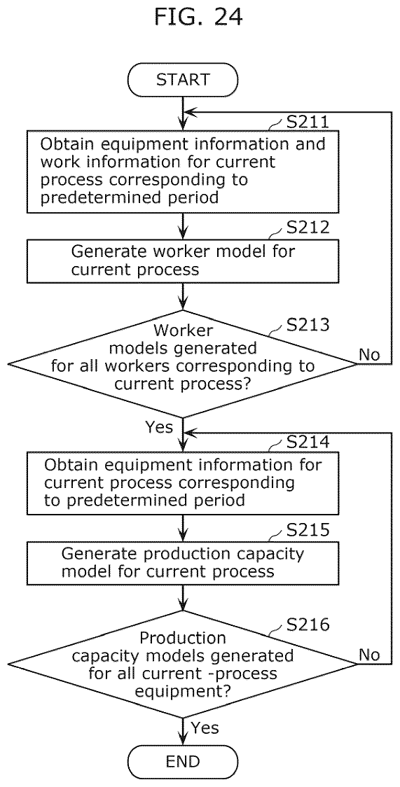

FIG. 24 is a flowchart illustrating a process, performed by equipment recovery notification system 10 according to the present embodiment, for generating models for the current process. The process illustrated in FIG. 24 is executed after the process illustrated in FIG. 19. Alternatively, the process illustrated in FIG. 24 may be executed before the process illustrated in FIG. 19. Alternatively, the process illustrated in FIG. 24 and the process illustrated in FIG. 19 may be performed concurrently, i.e., in parallel.

First, model generator 230 of equipment recovery notification device 200 obtains the equipment information and work information for the current process corresponding to a predetermined period (S211). More specifically, model generator 230 reads out the equipment information related to the current-process equipment for a predetermined period from equipment information storage 221, and reads out the work information related to the current-process equipment for the predetermined period from work information storage 222. Note that the predetermined period is, for example, the same period as the data used for generating the machine learning model of the subsequent-process equipment, but may be a different period.

Model generator 230 generates a worker model for the current process based on the obtained information (S212). The worker model for the current process is generated for each worker, and is a model for estimating a work time distribution for a case in which the corresponding worker performs recovery work on the current-process equipment. The worker model for the current process is the same as the worker model for the subsequent process, and differs in that it is generated using information related to the current process instead of information related to the subsequent process.

Model generator 230 repeatedly performs steps S211 and S212 until worker models are generated for all workers who perform recovery work on the plurality of units of current-process equipment (No in S213).

After worker models are generated for all workers corresponding to the current process (Yes in S213), model generator 230 obtains the equipment information for the current process corresponding to a predetermined period (S214). More specifically, model generator 230 reads out the equipment information related to the current-process equipment for a predetermined period from equipment information storage 221.

Model generator 230 generates a production capacity model for the current-process equipment based on the obtained information (S215). The production capacity model is generated for each unit of current-process equipment, and is a model for estimating the productivity of the corresponding current-process equipment. The production capacity model for the current process is the same as the production capacity model for the subsequent process, and differs in that it is generated using information related to the current process instead of information related to the subsequent process.

Model generator 230 repeatedly performs steps S214 and S215 until production capacity models are generated for all units of current-process equipment (No in S216). When production capacity models have been generated for all units of current-process equipment (Yes in S216), the process of the learning phase ends.

Note that although FIG. 24 illustrates an example in which the production capacity model is generated after generating the worker model, the present disclosure is not limited to this example. For example, the worker model may be generated after generating the production capacity model. Alternatively, the processes of generating the two models may be performed concurrently, i.e., in parallel.

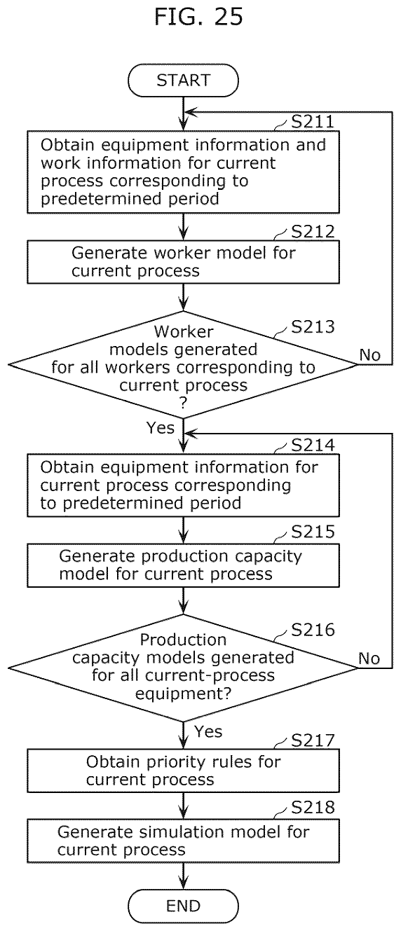

Model generator 230 may generate a simulation model for the current process after integrating the two models. FIG. 25 is a flowchart illustrating another example of a process for generating models for a current process performed by equipment recovery notification system 10 according to the present embodiment.

In the example illustrated in FIG. 25, the processes of steps S211 to S216 are the same as those in FIG. 24. After worker models for all workers in the current process and production capacity models for all current-process equipment have been generated (Yes in S216), model generator 230 obtains priority rules for the current process (S217). A priority rule is information indicating conditions for setting the priority of recovery work. For example, the priority is set based on target current-process equipment and the stoppage factor (stoppage code) thereof, as well as the productivity of current-process equipment associated with the stoppage factor. For example, a priority rule defines a priority setting method.

Model generator 230 generates a simulation model for the current process by integrating the worker models and the production capacity models based on the priority rule (S218). The simulation model for the current process is, for example, a model that, when information related to each unit of stopped equipment and the workers performing recovery work is input, sets and outputs a priority for each of the plurality of units of stopped manufacturing equipment 100 based on the priority rule.

### 2-2. Equipment Recovery Notification Process

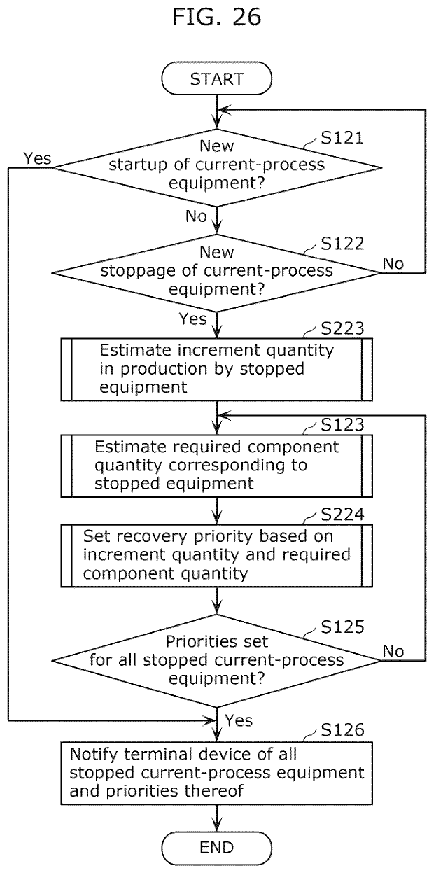

In the usage phase, the process for identifying the target equipment (steps S13a, S13b, S18b, and S18b in FIG. 17) differs from that of Embodiment 1. More specifically, in identifying the target equipment, the equipment recovery notification process illustrated in FIG. 26 is performed.

FIG. 26 is a flowchart illustrating an equipment recovery notification process performed by equipment recovery notification system 10 according to the present embodiment.

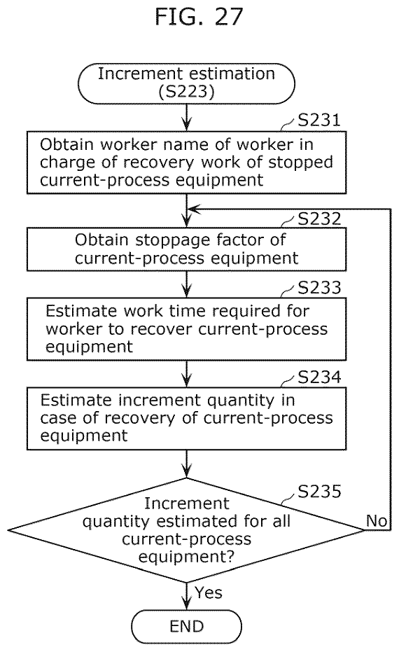

As illustrated in FIG. 26, equipment recovery notification device 200 stands by until a new startup (recovery) of the current-process equipment occurs or a new stoppage of the current-process equipment occurs (No in S121 and No in S122). When a new stoppage of the current-process equipment occurs (Yes in S122), estimator 240 of equipment recovery notification device 200 estimates an increment quantity in production by the stopped current-process equipment (S223). The increment quantity is the number of components that will be produced in a predetermined period once the stopped current-process equipment is recovered. A specific process for calculating the increment quantity will be described later with reference to FIG. 27.

Thereafter, estimator 240 estimates the required quantity of components (S123). A specific example of the estimation process for the required quantity of components is the same as in Embodiment 1, and is as described with reference to FIG. 22. The estimation of the required quantity of components (S123) may be performed before the estimation of the increment quantity (S223), or may be performed concurrently, i.e., in parallel.

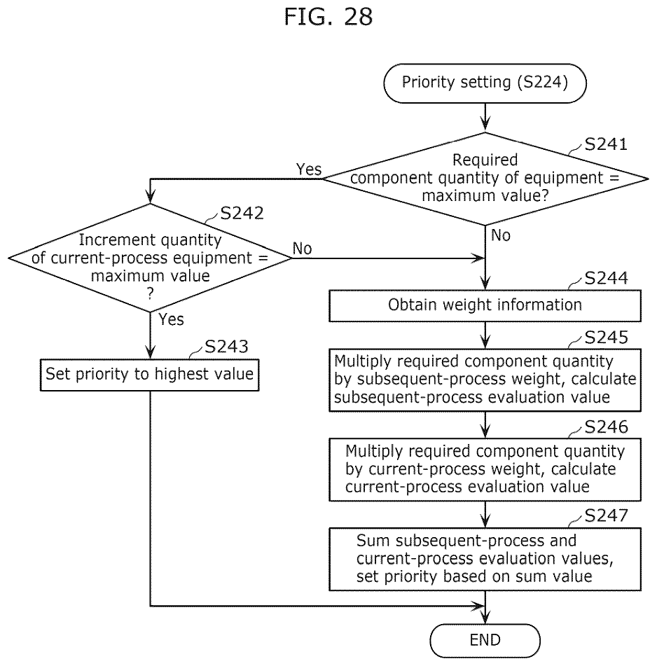

Next, identifier 250 of equipment recovery notification device 200 sets a priority for the recovery work based on the estimated increment quantity and estimated required quantity of components (S224). More specifically, the greater the required quantity of components, the higher identifier 250 sets the priority. A specific process for setting the priority will be described later with reference to FIG. 28.

Steps S123 and S224 are repeated until the priorities are set for all stopped current-process equipment (No in S125).

After priorities are set for all stopped current-process equipment (Yes in S125), notifier 260 notifies terminal device 300, via communicator 213, of all the stopped current-process equipment and their priorities (S126). This notification is also performed when a new startup of current-process equipment occurs (Yes in S121). Stated differently, when the number of stopped current-process equipment decreases as a result of recovery work being performed, a notification is transmitted excluding the current-process equipment that started operating.

### 2-3. Process for Estimating Increment Quantity

Next, the process for estimating the increment quantity (S223) will be described with reference to FIG. 27. FIG. 27 is a flowchart illustrating the process for estimating an increment quantity (S223) performed by equipment recovery notification system 10 according to the present embodiment.

First, estimator 240 of equipment recovery notification device 200 obtains the worker name of the worker in charge of the recovery work of the stopped current-process equipment (S231). The assignment of workers to the current-process equipment is predetermined based on information input via inputter 214, and is stored in, for example, work information storage 222.

Next, estimator 240 obtains the stoppage factor of the current-process equipment (S232). More specifically, estimator 240 obtains the stoppage factor included in the stoppage information transmitted from current-process equipment via communicator 213.

Next, estimator 240 estimates the work time required for the worker to recover the current-process equipment using the current process worker model (S233). Next, estimator 240 estimates the increment quantity that would be produced in the event that the current-process equipment were recovered (S234). More specifically, estimator 240 calculates the operating time by subtracting the estimated work time from the predetermined period (the same period as the period set in the estimation of the required quantity of components in step S123). Using the calculated operating time and the production capacity model of the current-process equipment, estimator 240 estimates the production quantity of the current-process equipment as the increment quantity. Note that estimator 240 may estimate the increment quantity using the capacity information of the current-process equipment corresponding to the capacity information illustrated in FIG. 15 instead of the production capacity model.

Steps S232 through S234 are repeated until the increment quantity is calculated for all stopped current-process equipment (No in S235).

This makes it possible to calculate, for all stopped current-process equipment, the increment quantity of components for a case in which recovery work is performed.

### 2-4. Priority Setting Process

Next, the priority setting process (S224) will be described with reference to FIG. 28. FIG. 28 is a flowchart illustrating the priority setting process (S224) performed by equipment recovery notification system 10 according to the present embodiment.

First, when the required quantity of components for the target current-process equipment (current-process equipment targeted in S123) is the maximum and the increment quantity is the maximum (Yes in S241 and Yes in S242), identifier 250 of equipment recovery notification device 200 sets the priority of the target current-process equipment to the highest value (S243). If the required quantity of components for the current-process equipment is not the maximum (No in S241), or if the increment quantity of the current-process equipment is not the maximum (No in S242), identifier 250 obtains weight information (S244).

Weight information is information indicating the respective weights of the current process and subsequent process. The weight is a parameter indicating the importance of the current process and the subsequent process, for example, when the objective is to improve the productivity of the entire production system. When the current process is more important than the subsequent process, the weight of the current process is set to a value greater than the weight of the subsequent process. When the subsequent process is more important than the current process, the weight of the subsequent process is set to a value greater than the weight of the current process. Note that the weight may be set for each unit of equipment.

Identifier 250 calculates a subsequent-process evaluation value by multiplying the required quantity of components by the weight of the subsequent process (S245), and calculates a current-process evaluation value by multiplying the increment quantity by the weight of the current process (S246). Identifier 250 sums the calculated subsequent-process evaluation value and current-process evaluation value, and sets a priority based on the sum value (S247). For example, the greater the sum value, the higher identifier 250 sets the priority.

The above processing is performed for all stopped current-process equipment, as illustrated in step S125 of FIG. 26. In the example of FIG. 2, the required quantity of components produced by each of current-process equipment B, D, and E, is calculated.

Hereinafter, an example will be given in which the increment quantity of components to be produced by the stopped current-process equipment is estimated as follows.
Increment quantity of component “b” by equipment B=5
Increment quantity of component “d” by equipment D=2
Increment quantity of component “e” by equipment E=5

In addition, the required quantity of components “b”, “d”, and “e” produced by current-process equipment B, D, and E, respectively, is as follows, similar to Embodiment 1.
Required quantity of component “b”=−4
Required quantity of component “d”=9
Required quantity of component “e”=4

In this case, when the weight of the current process is set to 0.3 and the weight of the subsequent process is set to 0.7, the sum for each of equipment B, D, and E of the current process is as follows.

Sum for equipment B=(Increment quantity of component“b”:5)×0.3+(Required quantity of component“b”:−4)×0.7=−1.3

Sum for equipment D=(Increment quantity of component“d”:2)×0.3+(Required quantity of component“d”:9)×0.7=6.9

Sum for equipment E=(Increment quantity of component“e”:5)×0.3+(Required quantity of component“e”:4)×0.7=4.3

In the present embodiment, the greater the required quantity of components, the higher the priority is set. In the above example, the priority of subsequent-process equipment D that produces component “d”, which has the greatest required quantity of components, is set the highest.

However, when the weight of the current process is set to 0.7 and the weight of the subsequent process is set to 0.3, the sum for each of equipment B, D, and E of the current process is as follows.

Sum for equipment B=(Increment quantity of component“b”:5)×0.7+(Required quantity of component“b”:−4)×0.3=2.3

Sum for equipment D=(Increment quantity of component“d”:2)×0.7+(Required quantity of component“d”:9)×0.3=4.1

Sum for equipment E=(Increment quantity of component“e”:5)×0.7+(Required quantity of component“e”:4)×0.3=5.7

In the present embodiment, the greater the required quantity of components, the higher the priority is set. Accordingly, in the above example, the priority of subsequent-process equipment E that produces component “e”, which has the greatest required quantity of components, is set the highest. In this way, depending on the weights, the equipment that is set with the highest priority may differ in some cases. Therefore, according to the weights of each process, more appropriate priorities are set, and further improvement of productivity can be supported.

According to the present embodiment, compared to a case in which only the productivity of the subsequent-process equipment (specifically, the required quantity of components) is utilized as in Embodiment 1, the equipment that is set with the highest priority may differ in some cases. Therefore, by taking into consideration the productivity of the equipment in the current process, further improvement of productivity can be supported.

The priority setting methods are not limited to the above examples. For example, the priority may be set based on a Pareto solution calculated using a priority function that satisfies both the increment quantity in the current process and the required component quantity in the subsequent process by multi-objective optimization.

Alternatively, the priority may be set based on a combination of the how high or low of the weight of the current process is, the how high or low the required quantity of components is, and how high or low the increment quantity is.

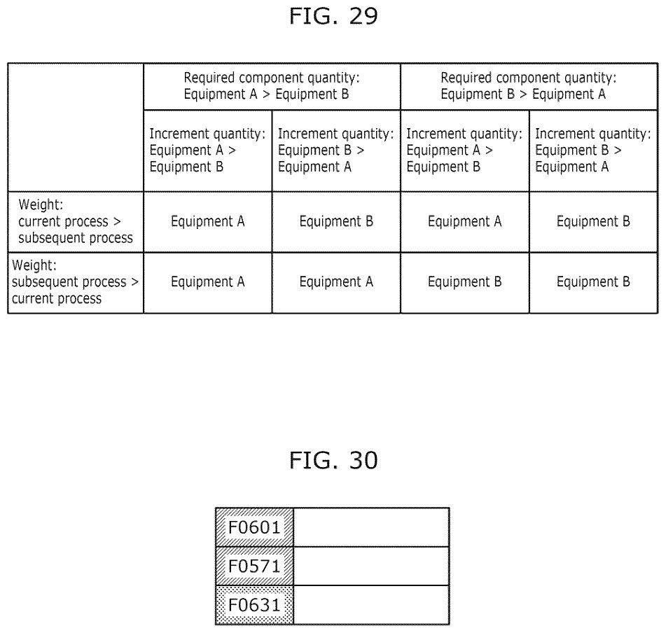

FIG. 29 illustrates an example of rules for setting priority by the equipment recovery notification system according to Embodiment 2. In FIG. 29, both equipment A and B are units of current-process equipment. According to the rules illustrated in FIG. 29, identifier 250 can set the priority as follows.

When (i) the weight of the subsequent process is greater than the weight of the current process, identifier 250 (a) sets the priority of equipment A higher than the priority of equipment B when the required quantity of components for equipment A is greater than the required quantity of components for equipment B and the increment quantity for equipment A is less than the increment quantity for equipment B. When (i) the weight of the subsequent process is greater than the weight of the current process, identifier 250 (b) sets the priority of equipment B higher than the priority of equipment A when the required quantity of components for equipment B is greater than the quantity of components for equipment A and the increment quantity for equipment B is less than the increment quantity for equipment A.

When (ii) the weight of the current process is greater than the weight of the subsequent process, identifier 250 (a) sets the priority of equipment B higher than the priority of equipment A when the required quantity of components for equipment A is greater than the required quantity of components for equipment B and the increment quantity for equipment A is less than the increment quantity for equipment B. When (ii) the weight of the current process is greater than the weight of the subsequent process, identifier 250 (b) sets the priority of equipment A higher than the priority of equipment B when the required quantity of components for equipment B is greater than the quantity of components for equipment A and the increment quantity for equipment B is less than the increment quantity for equipment A.

Regardless of how high or low the weight is, identifier 250 (a) sets the priority of equipment A higher than the priority of equipment B when the required quantity of components for equipment A is greater than the required quantity of components for equipment B and the increment quantity for equipment A is greater than the increment quantity for equipment B. Regardless of how high or low the weight is, identifier 250 (b) sets the priority of equipment B higher than the priority of equipment A when the required quantity of components for equipment B is greater than the required quantity of components for equipment A and the increment quantity for equipment B is greater than the increment quantity for equipment A.

In Embodiment 1, when the weights and increment quantities are not considered, identifier 250 may set the priorities based only on the comparison result of the required quantities of components. More specifically, identifier 250 (i) sets the priority of equipment A higher than the priority of equipment B when the required quantity of components for equipment A is greater than the required quantity of components for equipment B. Identifier 250 (ii) sets the priority of equipment B higher than the priority of equipment A when the required quantity of components for equipment B is greater than the required quantity of components for equipment A. Moreover, identifier 250 is not required to set priorities. Identifier 250 may (i) identify equipment A as the target component when the required quantity of components for equipment A is greater than the required quantity of components for equipment B, and (ii) identify equipment B as the target equipment when the required quantity of components for equipment B is greater than the required quantity of components for equipment A.

### Display Example

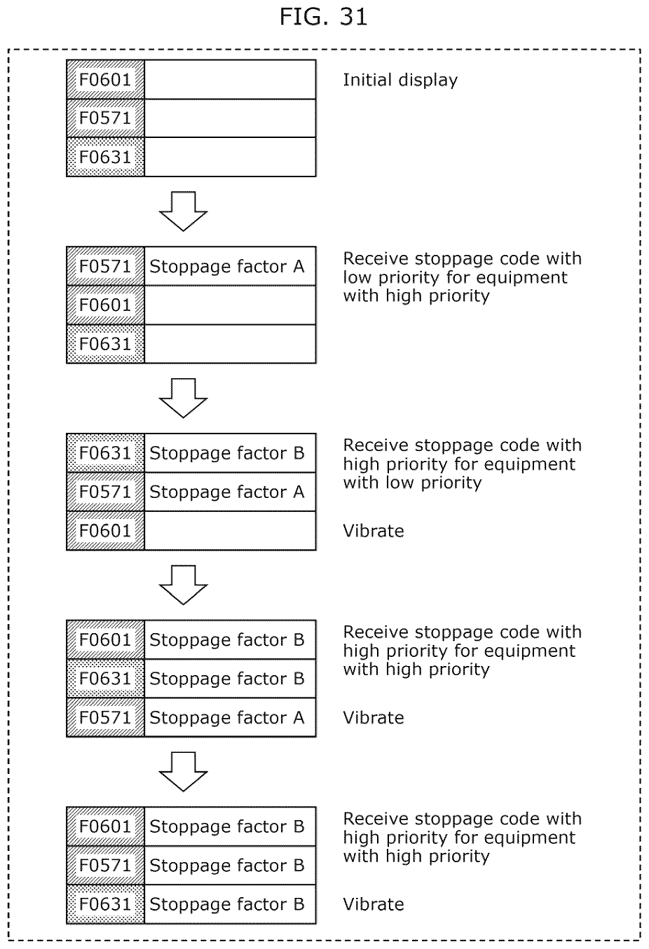

Next, examples of displaying notification images by the equipment recovery notification system according to the above embodiments will be described with reference to FIG. 30 and FIG. 31.

FIG. 30 illustrates one example of a display screen displayed by equipment recovery notification system 10 according to the above embodiments. The display screen illustrated in FIG. 30 is displayed, for example, on display 315 of terminal device 300.

In FIG. 30, the equipment names of three stopped units of equipment are arranged from top to bottom in descending order of priority. The difference in priority can be indicated, for example, by the difference in background color of the equipment names. In FIG. 30, the difference in background color is represented by the difference in shading applied in the frames. Here, an example is shown where the two units of equipment “F0601” and “F0571” have the highest priority.

The method of displaying priority is not limited to background color. The numerical values of the priorities themselves may be displayed in association with the equipment names. Alternatively, as illustrated in FIG. 30, the difference in priority may be represented by the difference in shading within the frames. Alternatively, the difference in priority may be represented by text color, text size, or the font of the equipment names.

FIG. 31 illustrates one example of transitions of display screens displayed by equipment recovery notification system 10 according to the above embodiments. Here, we assume the display screen in FIG. 30 is the initial state. FIG. 31 illustrates an example of rearranging the display based on the priority of the stoppage factors.

The stoppage factor priority is a priority set so as to increase the productivity of the current-process equipment, and is set based on the increment quantity resulting from the recovery. The equipment priority is a priority set so as to increase the productivity of the subsequent-process equipment, and is set based on the required quantity of components in the subsequent-process equipment. Here, the stoppage factor priority and the equipment priority are each set, and an example is shown in which the display is changed according to the weights in the display stage. In the example illustrated in FIG. 31, the weight of the current process is greater than the weight of the subsequent process, that is, an example is shown in which the priority of the current-process equipment is prioritized.

First, as a result of receiving stoppage factor A (stoppage code), which has a low priority, for equipment F0571, which has a high priority, equipment F0571 is arranged at the top. Equipment F0601 is arranged in the illustrated order because it has a higher priority than equipment F0631.

Next, as a result of receiving stoppage factor B, which has a high priority, for equipment F0631, which has a low priority, equipment F0631 is arranged at the top. In FIG. 31, stoppage factors with high priority are represented in bold. When a stoppage factor with a high priority is received, terminal device 300 may vibrate.

Next, as a result of receiving stoppage factor B, which has a high priority, for equipment F0601, which has a high priority, equipment F0601 is arranged at the top. Equipment F0631 is arranged in the illustrated order because stoppage factor B, which has a higher priority than equipment F0571, was received.

Next, when stoppage factor B, which has a high priority, is also received for equipment F0571, which has a high priority, the priorities of all the stoppage factors become the same, so the order becomes the priority order of the equipment. More specifically, the order becomes the initial state order.

### Other Embodiments

Hereinbefore, the equipment recovery notification method according to one or more aspects has been described based on embodiments, but the present disclosure is not limited to these embodiments. Various modifications to the present embodiment that may be conceived by those skilled in the art, as well as embodiments resulting from combinations of elements from different embodiments, are intended to be included within the scope of the present disclosure as long as these do not depart from the essence of the present disclosure.

For example, in the above embodiments, an example in which equipment recovery notification system 10 includes terminal device 300 for each worker was given, but the present disclosure is not limited to this example. For example, equipment recovery notification system 10 may include a display device such as a large screen provided in factory 1. The notification image from equipment recovery notification device 200 may be displayed on the display device and may be visible from inside factory 1.

For example, while the notification image displays the equipment names of all stopped current-process equipment arranged, the present disclosure is not limited to this example. Only the equipment name of the target equipment with the highest priority may be displayed. Alternatively, the equipment names of a predetermined number of current-process equipment may be displayed in order of priority from highest to lowest. Instead of arranging in order of priority, the priority may be displayed for each equipment name.

Moreover, for example, the processing of the learning phase may be executed by a device different from equipment recovery notification system 10. Stated differently, equipment recovery notification system 10 and equipment recovery notification device 200 may perform the processing of the usage phase by utilizing a machine learning model created by another device.

The communication method between devices described in the above embodiment is not particularly limited. In cases in which wireless communication is performed between devices, the wireless communication method (communication standard) is, for example, short-range wireless communication such as ZigBee (registered trademark), Bluetooth (registered trademark), or wireless local area network (LAN). Alternatively, the wireless communication method (communication standard) may be communication via a wide area communication network such as the Internet. Wired communication may be performed between devices instead of wireless communication. More specifically, wired communication is communication using power line communication (PLC) or wired LAN.

In the above embodiments, processing performed by a particular processor may be performed by a different processor. The order of the plurality of processes may be changed, or the plurality of processes may be executed in parallel. In the above embodiments, the allocation of elements of the work notification system to the devices is merely one example. For example, an element included in one device may be included in another device.

For example, the processing described in the above embodiments may be realized by centralized processing using a single device (system), or may be realized by distributed processing using a plurality of devices. The processor that executes the program described above may be a single processor or a plurality of processors. Stated differently, the processing may be centralized or distributed.

In the above embodiments, all or part of the elements such as the controller may be configured using dedicated hardware, or may be implemented by executing a software program suitable for each element. Each element may be implemented by a program execution unit such as a Central Processing Unit (CPU) or processor reading and executing a software program recorded on a recording medium such as an HDD or semiconductor memory.

The elements such as the controller may be configured of one or more electronic circuits. The one or more electronic circuits may each be a general-purpose circuit or a dedicated circuit.

The one or more electronic circuits may include, for example, a semiconductor device, an integrated circuit (IC), or a large scale integrated (LSI) circuit. The IC or LSI circuit may be integrated on a single chip, or may be integrated on a plurality of chips. Although these circuits are referred to as IC or LSI circuit here, the terminology may change depending on the degree of integration, and these circuits may be called system LSI circuit, a very large scale integrated (VLSI) circuit, or an ultra large scale integrated (ULSI) circuit. A field programmable gate array (FPGA) that is programmed after manufacturing the LSI circuitry can be used for the same purpose.

General or specific aspects of the present disclosure may be realized as a system, an apparatus or device, a method, an integrated circuit, or a computer program. Alternatively, the computer program may be realized on a computer-readable non-transitory recording medium such as an optical disc, an HDD, or semiconductor memory. Any given combination of a system, an apparatus or device, a method, an integrated circuit, a computer program, and a recording medium may be used to realize the aspects.

Various changes, substitutions, additions, omissions, etc., can be made to each of the above embodiments within the scope of the claims or their equivalents.

### INDUSTRIAL APPLICABILITY

The present disclosure is applicable as an equipment recovery notification method or the like that can support the improvement of productivity, and is applicable, for example, in factory management systems and factory production systems.

### REFERENCE SIGNS LIST

1 factory
2A, 2B, 2C, 2D worker
10 equipment recovery notification system
100, 100a, 100b, 100c manufacturing equipment
111, 211, 311 storage
112, 212, 312 processor
113, 213, 313 communicator
114, 214, 314 inputter
115, 215, 315 display
121 material inserter
122 conveyor
123 manufacturing part
124 product outputter
131 operation timepoint identifier
132 stoppage timepoint identifier
141 stoppage factor identifier
200 equipment recovery notification device
221 equipment information storage
222 work information storage
223 component information storage
230 model generator
240 estimator
250 identifier
260 notifier
300 terminal device
316 voice outputter
317 vibrator
400 network

1. An equipment recovery notification method comprising:
when two or more units of equipment among units of equipment that execute a first process are stopped, estimating, from among one or more units of subsequent-process equipment that execute a second process subsequent to the first process, a productivity of one or more units of the subsequent-process equipment that use at least one of components produced by the two or more units of equipment;
identifying one unit of equipment among the two or more units of equipment as target equipment for recovery work, based on the productivity of the one or more units of subsequent-process equipment; and
notifying of the target equipment identified.

2. The equipment recovery notification method according to claim 1, wherein
the identifying includes setting a priority for each of the two or more units of equipment based on the productivity of the one or more units of subsequent-process equipment, and identifying, from among the two or more units of equipment, a unit of equipment for which the priority set is higher than a threshold value as the target equipment.

3. The equipment recovery notification method according to claim 1, wherein
the identifying includes setting a priority for each of the two or more units of equipment based on the productivity of the one or more units of subsequent-process equipment, comparing the priorities set, and identifying, from among the two or more units of equipment, a unit of equipment for which the priority set is higher than others as the target equipment.

4. The equipment recovery notification method according to claim 2, wherein
when a first unit of equipment among the units of equipment is stopped and a second unit of equipment different from the first unit of equipment among the units of equipment stops, the estimating includes estimating a first component quantity and a second component quantity as the productivity of the one or more units of subsequent-process equipment, the first component quantity being a quantity, of a component produced by the first unit of equipment, required in a predetermined period in the second process, the second component quantity being a quantity, of a component produced by the second unit of equipment, required in the predetermined period in the second process, and
the identifying includes comparing the first component quantity and the second component quantity, and (a) setting a priority of the first unit of equipment higher than a priority of the second unit of equipment when the first component quantity is greater than the second component quantity, and (b) setting the priority of the second unit of equipment higher than the priority of the first unit of equipment when the second component quantity is greater than the first component quantity.

5. The equipment recovery notification method according to claim 2, wherein
the estimating includes further estimating a productivity of each of the two or more units of equipment, and
the identifying includes setting the priority for each of the two or more units of equipment further based on the productivity of each of the two or more units of equipment.

6. The equipment recovery notification method according to claim 5, wherein
when a first unit of equipment among the units of equipment is stopped and a second unit of equipment different from the first unit of equipment among the units of equipment stops, the estimating includes:
estimating a first component quantity and a second component quantity as the productivity of the one or more units of subsequent-process equipment, the first component quantity being a quantity, of a first component produced by the first unit of equipment, required in a predetermined period in the second process, the second component quantity being a quantity, of a second component produced by the second unit of equipment, required in the predetermined period in the second process; and
estimating a first increment quantity and a second increment quantity as a production quantity of each of the two or more units of equipment, the first increment quantity being a quantity by which the first component will increase in a case in which the first unit of equipment is recovered, and the second increment being a quantity by which the second component will increase in a case in which the second unit of equipment is recovered, and
the identifying includes (a) setting a priority of the first unit of equipment higher than a priority of the second unit of equipment when the first component quantity is greater than the second component quantity and the first increment quantity is greater than the second increment quantity, and (b) setting the priority of the second unit of equipment higher than the priority of the first unit of equipment when the second component quantity is greater than the first component quantity and the second increment quantity is greater than the first increment quantity.

7. The equipment recovery notification method according to claim 6, further comprising:
obtaining weight information indicating a weight of the first process and a weight of the second process, wherein
the identifying includes:
multiplying each of the first component quantity and the second component quantity by the weight of the second process;
multiplying each of the first increment quantity and the second increment quantity by the weight of the first process;
calculating a first evaluation value and a second evaluation value, the first evaluation value being a sum of the first component quantity multiplied by the weight of the second process and the first increment quantity multiplied by the weight of the first process, the second evaluation value being a sum of the second component quantity multiplied by the weight of the second process and the second increment quantity multiplied by the weight of the first process; and
(a) setting the priority of the first unit of equipment higher than the priority of the second unit of equipment when the first evaluation value is greater than the second evaluation value, and (b) setting the priority of the second unit of equipment higher than the priority of the first unit of equipment when the second evaluation value is greater than the first evaluation value.

8. The equipment recovery notification method according to claim 6, further comprising:
obtaining weight information indicating a weight of the first process and a weight of the second process, wherein
(i) when the weight of the second process is greater than the weight of the first process, the identifying includes:
(a) setting the priority of the first unit of equipment higher than the priority of the second unit of equipment when the first component quantity is greater than the second component quantity and the first increment quantity is less than the second increment quantity; and
(b) setting the priority of the second unit of equipment higher than the priority of the first unit of equipment when the second component quantity is greater than the first component quantity and the second increment quantity is less than the first increment quantity, and
(ii) when the weight of the first process is greater than the weight of the second process, the identifying includes:
(a) setting the priority of the second unit of equipment higher than the priority of the first unit of equipment when the first component quantity is greater than the second component quantity and the first increment quantity is less than the second increment quantity; and
(b) setting the priority of the first unit of equipment higher than the priority of the second unit of equipment when the second component quantity is greater than the first component quantity and the second increment quantity is less than the first increment quantity.

9. The equipment recovery notification method according to claim 6, wherein
the estimating includes:
estimating a first usage quantity and a second usage quantity, the first usage quantity being a quantity of the first component to be used in the predetermined period in the second process, the second usage quantity being a quantity of the second component to be used in the predetermined period in the second process;
obtaining a first unused quantity and a second unused quantity, the first unused quantity being a quantity of the first component that has not yet been used in the second process, the second unused quantity being a quantity of the second component that has not yet been used in the second process;
calculating the first component quantity by subtracting the first unused quantity from the first usage quantity; and
calculating the second component quantity by subtracting the second unused quantity from the second usage quantity.

10. The equipment recovery notification method according to claim 9, wherein
the estimating includes:
when the subsequent-process equipment includes a plurality of units of subsequent-process equipment that use the first component, estimating, for each of the plurality of units of subsequent-process equipment, a quantity of the first component to be used in the predetermined period, and calculating the first usage quantity by summing the quantities estimated; and
when the subsequent-process equipment includes a plurality of units of subsequent-process equipment that use the second component, estimating, for each of the plurality of units of subsequent-process equipment, a quantity of the second component to be used in the predetermined period, and calculating the second usage quantity by summing the quantities estimated.

11. The equipment recovery notification method according to claim 9 or 10, wherein
the estimating includes:
when a unit of the subsequent-process equipment that uses the first component satisfies a predetermined condition, setting a quantity of the first component to be used by the unit of the subsequent-process equipment to zero; and
when a unit of the subsequent-process equipment that uses the second component satisfies a predetermined condition, setting a quantity of the second component to be used by the unit of the subsequent-process equipment to zero.

12. The equipment recovery notification method according to claim 2, further comprising:
obtaining:
equipment information including an operating and stoppage status of each of the units of equipment, an operating and stoppage status of each of the one or more units of subsequent-process equipment, and a stoppage factor of each of the one or more units of subsequent-process equipment that is stopped;
component type information including a type of component produced by each of the units of equipment; and
correspondence information indicating, for each type of component produced by the units of equipment, the subsequent-process equipment that uses the component in the second process, wherein
in the estimating, the productivity of the one or more units of subsequent-process equipment is estimated by inputting the equipment information, the component type information, and the correspondence information into a machine learning model generated by machine learning.

13. The equipment recovery notification method according to claim 2, wherein
the notifying includes displaying a notification image in which two or more items of equipment identification information respectively representing the two or more units of equipment are arranged in descending order of priority of the two or more units of equipment.

14. The equipment recovery notification method according to claim 13, wherein
the notifying includes updating the notification image each time there is an increase or decrease in the two or more units of equipment.

15. The equipment recovery notification method according to claim 1, wherein
when a first unit of equipment among the units of equipment is stopped and a second unit of equipment different from the first unit of equipment among the units of equipment stops, the estimating includes estimating a first component quantity and a second component quantity as the productivity of the one or more units of subsequent-process equipment, the first component quantity being a quantity, of a component produced by the first unit of equipment, required in a predetermined period in the second process, the second component quantity being a quantity, of a component produced by the second unit of equipment, required in the predetermined period in the second process, and
the identifying includes comparing the first component quantity and the second component quantity, and (i) identifying the first unit of equipment as the target equipment when the first component quantity is greater than the second component quantity, and (ii) identifying the second unit of equipment as the target equipment when the second component quantity is greater than the first component quantity.

16. An equipment recovery notification device comprising:
an estimator that, when two or more units of equipment among units of equipment that execute a first process are stopped, estimates, from among one or more units of subsequent-process equipment that execute a second process subsequent to the first process, a productivity of one or more units of the subsequent-process equipment that use at least one of components produced by the two or more units of equipment;
an identifier that identifies one unit of equipment among the two or more units of equipment as target equipment for recovery work, based on the productivity of the one or more units of subsequent-process equipment; and
a notifier that notifies of the target equipment identified.

17. An equipment recovery notification system comprising:
the equipment recovery notification device according to claim 16; and
a terminal device that outputs information for a worker of the recovery work to identify the target equipment.
